(19) United States
(12) Patent Application Publication
(10) Pub. No.: US 2009/0009702 A1
(43) Pub. Date: Jan. 8, 2009

(54) Liquid Crystal Device and Electronic Apparatus

(75) Inventor: Kosuke Chidate, Chino-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 12/164,270

(22) Filed: Jun. 30, 2008

(30) Foreign Application Priority Data
Jul. 2, 2007 (JP) 2007-173701
Jul. 10, 2007 (JP) 2007-180808
Mar. 27, 2008 (JP) 2008-084512
Mar. 27, 2008 (JP) 2008-084526

(51) Int. Cl. G02F 1/13363

(52) U.S. Cl. 349/120; 349/119

(57) ABSTRACT

A liquid crystal device includes a pair of substrates, a liquid crystal, a first optical compensation element, and a second optical compensation element. The liquid crystal is pretilted by the alignment layers. The first optical compensation element has a positive uniaxiality and a first optical axis inclined in a direction different from the pretilted direction of the liquid crystal molecules. The second optical compensation element has a positive uniaxiality and a second optical axis aligned with the pair of substrates.

### CROSS REFERENCE TO RELATED APPLICATIONS

The present application claims priority and incorporates herein by reference in its entirety Japanese Patent Application No. 2007-173701 filed Jul. 2, 2007 and Japanese Patent Application No. 2007-180808 filed Jul. 10, 2007 and Japanese Patent Application No. 2008-084512 filed Mar. 27, 2008 and Japanese Patent Application No. 2008-084526 filed Mar. 27, 2008.

### BACKGROUND

Some liquid crystal devices of this type include an optical phase difference compensation element, such as a retardation film, for example, in order to prevent a decrease in contrast due to an optical phase difference (or a phase shift) that occurs in a liquid crystal layer.

In regard to such the optical phase difference compensation element, as shown in the Japanese Patent Publication No. JP-A-2006-11298, for example, describes a technology in which an optical anisotropic element, which is formed of an inorganic dielectric multilayer, is arranged obliquely in accordance with the alignment direction of liquid crystal molecules for a vertical alignment liquid crystal element.

However, for example, when an optical anisotropic element is arranged obliquely as in the technology described in the Japanese Patent Publication No. JP-A-2006-11298, it is necessary to ensure a space for arranging the optical anisotropic element. Thus, there is a technical problem that it is difficult to reduce the size of a liquid crystal device or the size of a projector that includes the liquid crystal device, and the flexibility of layout are also inhibited.

Furthermore, because the optical anisotropic element is inclined in accordance with the alignment direction of the liquid crystal molecules, there is a technical problem that, depending on the alignment direction, a mechanism for inclining the optical anisotropic element becomes complex or additional adjustment may possibly be required in an assembling process.

### SUMMARY

A liquid crystal device, such as a liquid crystal light bulb, and also an electronic apparatus, such as a liquid crystal projector, have been developed in response to the current state of the art, and in particular, in response to these and other problems, needs, and demands that have not been fully or completely solved by currently available liquid crystal device and projector systems. More specifically, various embodiments described in the disclosure provide a liquid crystal device that is able to display a relatively high-contrast and high-quality image and is suitable for miniaturization. Various embodiments described in the disclosure also provide an electronic apparatus that includes the liquid crystal device.

One embodiment provides a liquid crystal device. The liquid crystal device includes a pair of substrates, a liquid crystal, a first optical compensation element, and a second optical compensation element. The pair of substrates are arranged so as to face each other, and an alignment layer is provided for each of the pair of substrates. The liquid crystal is held between the pair of substrates and is formed of liquid crystal molecules that are pretilted by the alignment layers. The first optical compensation element has a positive uniaxiality and has a first optical axis, as an optical axis, that is inclined in a direction different from a direction in which major axes of the pretilted liquid crystal molecules incline with respect to one plane that is oriented along the pair of substrates. The second optical compensation element has a positive uniaxiality and has a second optical axis, as an optical axis, that is oriented along the one plane.

According to the liquid crystal device of at least one embodiment, the pair of substrates are arranged so as to face each other, and the liquid crystal is held between the pair of substrates. The liquid crystal is typically a vertical alignment liquid crystal, that is, a VA (Vertical Alignment) liquid crystal. The alignment layer is provided for each of the pair of substrates. The alignment layers pretilt the liquid crystal molecules, which constitute the liquid crystal, so as to be raised at a predetermined angle in a predetermined direction. For example, when the liquid crystal is a VA liquid crystal, the liquid crystal molecules are aligned so that they are inclined at a pretilt angle in a predetermined direction with respect to the normal line of the one plane that is oriented along the pair of substrates. For example, when the liquid crystal is a TN (Twisted Nematic) liquid crystal, the liquid crystal molecules are aligned so that they are inclined at a pretilt angle in a predetermined direction with respect to the one plane that is oriented along the pair of substrates. The above alignment layers each are typically an organic alignment layer on which rubbing is performed in a predetermined direction. Alternatively, the alignment layers each may be an inorganic alignment layer. When the liquid crystal device is operating, light, such as projection light, enters the liquid crystal device and then the liquid crystal device serves as a liquid crystal light bulb.

In at least one embodiment, particularly, the first and second optical compensation elements are provided. Each of the first and second optical compensation elements is provided to a side of the pair of substrates, from which light enters or from which light exits. The first optical compensation element has a positive uniaxiality and, for example, includes a positive uniaxial crystal. The first optical axis, which is the optical axis of the first optical compensation element, is inclined in a direction different from a direction in which the major axes of the pretilted liquid crystal molecules incline with respect to the one plane that is oriented along the pair of substrates. That is, the direction in which the first optical axis is inclined with respect to the one plane that is oriented along the pair of substrates is different from the direction in which the major axes of the liquid crystal molecules incline with respect to the one plane that is oriented along the pair of substrates at portions that contact the alignment layers at the time when the liquid crystal device is not operating. For example, when the liquid crystal is a VA liquid crystal, the first optical axis is typically oriented along a direction that is symmetrical with the major axes of the pretilted liquid crystal molecules with respect to the one plane that is oriented along the pair of substrates. The second optical compensation element is, for example, formed of a positive uniaxial retardation film (that is, A plate), and the second optical compensation element is arranged so as to face the pair of substrates so that the second optical axis, which is the optical axis of the second optical compensation element, is oriented along the pair of substrates. The second optical axis typically intersects with the first optical axis when viewed in the direction of the normal line of the one plane that is oriented along the pair of substrates. For example, when the liquid crystal is a VA liquid crystal, the second optical axis typically intersects with the major axes of the pretilted liquid crystal molecules when viewed in the direction of the normal line of the one plane that is oriented along the pair of substrates.

Thus, for example, when the liquid crystal device, which serves as a liquid crystal light bulb, is operating, it is possible for the first and second optical compensation elements to compensate for a light phase difference that occurs when incident light passes through the liquid crystal formed of the liquid crystal molecules that are inclined with respect to the pair of substrates. In other words, it is possible for the first and second optical compensation elements to reduce the anisotropy of overall refractive index of a set of the liquid crystal held between the pair of substrates and the first and second optical compensation elements. That is, it is possible to approximate the index ellipsoid, which indicates the anisotropy of overall refractive index of a set of the liquid crystal and the first and second optical compensation elements, to a sphere. By performing the above compensation, it is possible to prevent light that has passed through the liquid crystal from entering the outgoing side polarizer in a state where the phase is shifted. Thus, for example, in the outgoing side polarizer, there is less possibility that light, which is normally not allowed to be passed, will leak, and thereby it is possible to prevent a decrease in contrast and a reduction in viewing angle range.

Furthermore, although the first and second optical compensation elements are never arranged obliquely with respect to the pair of substrates, it is possible to compensate for a light phase difference that occurs in the liquid crystal. Thus, it is suitable for miniaturization of the liquid crystal device, and the like.

Note that each of the first and second optical compensation elements may be provided on the side of the pair of substrates, from which light enters (in other words, the side of the liquid crystal, from which light enters) or may be provided on the side of the pair of substrates, from which light exits.

Note that not only the VA liquid crystal but also a TN liquid crystal, an OCB (Optically Compensated Birefringence) liquid crystal, or the like, may also be effectively compensated by appropriately setting the relationship between the first optical axis and the second optical axis.

As described above, the liquid crystal device according to at least one embodiment is able to compensate for a phase difference that occurs in the liquid crystal by means of the first and second optical compensation elements. Thus, the liquid crystal device is able to display a relatively high-contrast and high-quality image and is also suitable for miniaturization.

In the liquid crystal device according to at least one embodiment, the first optical axis may intersect with the second optical axis when viewed in a direction of the normal line of the one plane.

According to the above aspect, in comparison with the case in which the first optical axis and the second optical axis are parallel to each other when viewed in the direction of the normal line of the one plane that is oriented along the pair of substrates, it is possible to reduce the anisotropy of overall refractive index of a set of the liquid crystal held between the pair of substrates and the first and second optical compensation elements.

In the above described aspect in which the first optical axis and the second optical axis intersect with each other, the first optical axis may be perpendicular to the second optical axis when viewed in the direction of the normal line of the one plane.

In this case, it is possible to further reduce the anisotropy of overall refractive index of a set of the liquid crystal held between the pair of substrates and the first and second optical compensation elements.

At least one embodiment provides a liquid crystal device. The liquid crystal device includes a pair of substrates, a liquid crystal, a pair of polarizers, a first optical compensation element, and a second optical compensation element. The pair of substrates are arranged so as to face each other, and an alignment layer is provided for each of the pair of substrates. The liquid crystal is held between the pair of substrates and is formed of liquid crystal molecules that are pretilted by the alignment layers. The pair of polarizers are arranged so as to place the pair of substrates in between. The first optical compensation element is arranged between the pair of polarizers. The first optical compensation element has a positive uniaxiality and has a first optical axis, as an optical axis, that is inclined in a direction different from a direction in which major axes of the pretilted liquid crystal molecules incline with respect to one plane that is oriented along the pair of substrates. The second optical compensation element is arranged between the pair of polarizers. The second optical compensation element has a phase retardation axis when viewed in a direction along the normal line of the one plane. The second optical compensation element is rotatable about an axis that is oriented along the normal line of the one plane.

According to the liquid crystal device of at least one embodiment, the pair of substrates are arranged so as to face each other, and the liquid crystal is held between the pair of substrates. The liquid crystal is typically a vertical alignment liquid crystal, that is, a VA liquid crystal. The alignment layer is provided for each of the pair of substrates. The alignment layers pretilt the liquid crystal molecules, which constitute the liquid crystal, so as to be raised at a predetermined angle in a predetermined direction. For example, when the liquid crystal is a VA liquid crystal, the liquid crystal molecules are aligned so that they are inclined at a pretilt angle in a predetermined direction with respect to the normal line of the one plane that is oriented along the pair of substrates. For example, when the liquid crystal is a TN liquid crystal, the liquid crystal molecules are aligned so that they are inclined at a pretilt angle in a predetermined direction with respect to the one plane that is oriented along the pair of substrates. The above alignment layers each are typically an organic alignment layer on which rubbing is performed in a predetermined direction. Alternatively, the alignment layers each may be an inorganic alignment layer. The pair of substrates between which the liquid crystal is held are arranged so as to be placed between the pair of polarizers. When the liquid crystal device is operating, light, such as projection light, enters the liquid crystal device and then the liquid crystal device serves as a liquid crystal light bulb.

In at least one embodiment, particularly, the first and second optical compensation elements are provided. Each of the first and second optical compensation elements is arranged between the pair of polarizers. More specifically, each of the first and second optical compensation elements is arranged between the pair of substrates and one of the pair of polarizers or between the pair of substrates and the other of the pair of polarizers. In other words, each of the first and second optical compensation elements is provided between the pair of polarizers and on the side of the pair of substrates, from which light enters, or on the side of the pair of substrates, from which light exits. The first optical compensation element has a positive uniaxiality and, for example, includes a positive uniaxial crystal. The first optical axis, which is the optical axis of the first optical compensation element, is inclined in a direction different from a direction in which the major axes of the pretilted liquid crystal molecules incline with respect to the one plane that is oriented along the pair of substrates. That is, the direction in which the first optical axis is inclined with respect to the one plane that is oriented along the pair of substrates is different from the direction in which the major axes of the liquid crystal molecules incline with respect to the one plane that is oriented along the pair of substrates at portions that contact the alignment layers at the time when the liquid crystal device is not operating. For example, when the liquid crystal is a VA liquid crystal, the first optical axis is typically oriented along a direction that is symmetrical with the major axes of the pretilted liquid crystal molecules with respect to the one plane that is oriented along the pair of substrates. The second optical compensation element has the phase retardation axis when viewed in the direction along the normal line of the one plane that is oriented along the pair of substrates, and, for example, formed of a positive uniaxial retardation film (that is, A plate) or a biaxial plate. The second optical compensation element is arranged so as to face the pair of substrates so that the phase retardation axis of the second optical compensation element is oriented along the pair of substrates and, in addition, is rotatable about the axis that is oriented along the normal line of the one plane that is oriented along the pair of substrates. Thus, for example, the second optical compensation element may be adjusted by rotation so as to cancel a light phase difference that occurs because of the liquid crystal and the first optical compensation element or so as to be able to minutely adjust the state of polarization of light.

Thus, for example, when the liquid crystal device, which serves as a liquid crystal light bulb, is operating, it is possible for the first and second optical compensation elements to compensate for a light phase difference that occurs when incident light passes through the liquid crystal formed of the liquid crystal molecules that are inclined with respect to the pair of substrates. In short, the first optical compensation element, which has the first optical axis that is inclined in a direction different from a direction in which the major axes of the liquid crystal molecules incline, is arranged for the liquid crystal that is formed of the pretilted liquid crystal molecules, so that the index ellipsoid that indicates the anisotropy of overall refractive index of a set of the liquid crystal and the first optical compensation element is approximated to a biaxial index ellipsoid. Thus, it is possible for the first optical compensation element to compensate for a phase difference that occurs from a state in which the major axes of the pretilted liquid crystal molecules are inclined with respect to the normal line of the one plane that is oriented along the pair of substrates. Furthermore, the second optical compensation element, which has the phase retardation axis that is oriented along the one plane and is rotatable about the axis that is oriented along the normal line of the one plane, is arranged for the liquid crystal and the first optical compensation element. The second optical compensation element is, for example, adjusted by rotation so as to cancel a light phase difference that occurs because of the liquid crystal and the first optical compensation element, so that it is possible to reduce the anisotropy of overall refractive index of a set of the liquid crystal and the first and second optical compensation elements. In addition, the second optical compensation element also serves to minutely adjust the state of polarization of light.

By performing the above compensation, it is possible to prevent light that has passed through the liquid crystal from entering the outgoing side polarizer in a state where the phase is shifted. Thus, for example, in the outgoing side polarizer, there is less possibility that light, which is normally not allowed to be passed, will leak, and thereby it is possible to prevent a decrease in contrast and a reduction in viewing angle range.

Furthermore, although the first and second optical compensation elements are never arranged obliquely with respect to the pair of substrates, it is possible to compensate for a light phase difference that occurs in the liquid crystal. Thus, it is suitable for miniaturization of the liquid crystal device, and the like.

Note that each of the first and second optical compensation elements may be provided on the side of the pair of substrates, from which light enters (in other words, the side of the liquid crystal, from which light enters) or may be provided on the side of the pair of substrates, from which light exits.

Note that not only the VA liquid crystal but also a TN liquid crystal, an OCB liquid crystal, or the like, may also be effectively compensated by appropriately setting the relationship between the first optical axis of the first optical compensation element and the phase retardation axis of the second optical compensation element.

As described above, the liquid crystal device according to at least one embodiment is able to compensate for a phase difference that occurs in the liquid crystal by means of the first and second optical compensation elements. Thus, the liquid crystal device is able to display a relatively high-contrast and high-quality image and is also suitable for miniaturization.

In the liquid crystal device according to at least one embodiment, the second optical compensation element may have a positive uniaxiality and have a second optical axis, as an optical axis, that is oriented along the one plane.

According to the above aspect, the second optical compensation element is arranged so as to face the pair of substrates so that the second optical axis of the second optical compensation element is oriented along the pair of substrates. Furthermore, the second optical compensation element is rotatable about the axis that is oriented along the normal line of the one plane that is oriented along the pair of substrates. Thus, for example, the second optical compensation element may be adjusted by rotation so as to cancel a light phase difference that occurs because of the liquid crystal and the first optical compensation element or so as to be able to minutely adjust the state of polarization of light.

At least one embodiment provides a liquid crystal device. The liquid crystal device includes a pair of substrates, a liquid crystal, a pair of polarizers, a first optical compensation element, and a second optical compensation element. The pair of substrates are arranged so as to face each other. An alignment layer is provided for each of the pair of substrates. The liquid crystal is held between the pair of substrates and is formed of liquid crystal molecules that are pretilted by the alignment layers. The pair of polarizers are arranged so as to place the pair of substrates in between. The first optical compensation element is arranged between the pair of polarizers. The first optical compensation element has a positive uniaxiality and has a first optical axis, as an optical axis, that is inclined in a direction different from a direction in which major axes of the pretilted liquid crystal molecules incline with respect to one plane that is oriented along the pair of substrates. The second optical compensation element is arranged between the pair of polarizers. The second optical compensation element has a negative index ellipsoid and has a phase retardation axis that occurs from a state in which a main axis of a refractive index of the negative index ellipsoid is inclined with respect to the one plane. The phase retardation axis is rotatable about an axis that is oriented along the normal line of the one plane.

According to the liquid crystal device of at least one embodiment, the pair of substrates are arranged so as to face each other, and the liquid crystal is held between the pair of substrates. The liquid crystal is typically a vertical alignment liquid crystal, that is, a VA liquid crystal. The alignment layer is provided for each of the pair of substrates. The alignment layers pretilt the liquid crystal molecules, which constitute the liquid crystal, so as to be raised at a predetermined angle in a predetermined direction. For example, when the liquid crystal is a VA liquid crystal, the liquid crystal molecules are aligned so that they are inclined at a pretilt angle in a predetermined direction with respect to the normal line of the one plane that is oriented along the pair of substrates. For example, when the liquid crystal is a TN liquid crystal, the liquid crystal molecules are aligned so that they are inclined at a pretilt angle in a predetermined direction with respect to the one plane that is oriented along the pair of substrates. The above alignment layers each are typically an organic alignment layer on which rubbing is performed in a predetermined direction. Alternatively, the alignment layers each may be an inorganic alignment layer. The pair of substrates between which the liquid crystal is held are arranged so as to be placed between the pair of polarizers. When the liquid crystal device is operating, light, such as projection light, enters the liquid crystal device and then the liquid crystal device serves as a liquid crystal light bulb.

In at least one embodiment, particularly, the first and second optical compensation elements are provided. Each of the first and second optical compensation elements is arranged between the pair of polarizers. More specifically, each of the first and second optical compensation elements is arranged between the pair of substrates and one of the pair of polarizers or between the pair of substrates and the other of the pair of polarizers. In other words, each of the first and second optical compensation elements is provided between the pair of polarizers and on the side of the pair of substrates, from which light enters, or on the side of the pair of substrates, from which light exits. The first optical compensation element has a positive uniaxiality and, for example, includes a positive uniaxial crystal. The first optical axis, which is the optical axis of the first optical compensation element, is inclined in a direction different from a direction in which the major axes of the pretilted liquid crystal molecules incline with respect to the one plane that is oriented along the pair of substrates. That is, the direction in which the first optical axis is inclined with respect to the one plane that is oriented along the pair of substrates is different from the direction in which the major axes of the liquid crystal molecules incline with respect to the one plane that is oriented along the pair of substrates at portions that contact the alignment layers at the time when the liquid crystal device is not operating. For example, when the liquid crystal is a VA liquid crystal, the first optical axis is typically oriented along a direction that is symmetrical with the major axes of the pretilted liquid crystal molecules with respect to the one plane that is oriented along the pair of substrates. The second optical compensation element has a negative index ellipsoid, and the negative index ellipsoid (or the main axis of the negative index ellipsoid) is inclined with respect to the one plane that is oriented along the pair of substrates. In addition, the phase retardation axis occurs in the second optical compensation element because of the inclined negative index ellipsoid. Here, the phase retardation axis according to the aspects of the disclosure means a direction in which the refractive index is maximal (in other words, a direction in which speed of light is minimal) when the three-dimensionally represented optical anisotropy (that is, index ellipsoid) is cut along the above described one plane. Furthermore, the phase retardation axis that occurs in the second optical compensation element is rotatable about the axis that is oriented along the normal line of the one plane that is oriented along the pair of substrates. Thus, for example, the second optical compensation element may be adjusted by rotation so as to cancel a light phase difference that occurs because of the liquid crystal and the first optical compensation element or so as to be able to minutely adjust the state of polarization of light.

Thus, for example, when the liquid crystal device, which serves as a liquid crystal light bulb, is operating, it is possible for the first and second optical compensation elements to compensate for a light phase difference that occurs when incident light passes through the liquid crystal formed of the liquid crystal molecules that are inclined with respect to the pair of substrates. In short, the first optical compensation element, which has the first optical axis that is inclined in a direction different from a direction in which the major axes of the liquid crystal molecules incline, is arranged for the liquid crystal that is formed of the pretilted liquid crystal molecules, so that the index ellipsoid that indicates the anisotropy of overall refractive index of a set of the liquid crystal and the first optical compensation element is approximated to a biaxial index ellipsoid. Thus, it is possible for the first optical compensation element to compensate for a phase difference that occurs from a state in which the major axes of the pretilted liquid crystal molecules are inclined with respect to the normal line of the one plane that is oriented along the pair of substrates. Furthermore, the second optical compensation element, of which the phase retardation axis that occurs from a state in which the negative index ellipsoid (or the main axis of the negative index ellipsoid) is inclined with respect to the one plane is rotatable about the axis that is oriented along the normal line of the one plane, is arranged for the liquid crystal and the first optical compensation element. The second optical compensation element is, for example, adjusted by rotation so as to cancel a light phase difference that occurs because of the liquid crystal and the first optical compensation element, so that it is possible to reduce the anisotropy of overall refractive index of a set of the liquid crystal and the first and second optical compensation elements. In addition, the second optical compensation element also serves to minutely adjust the state of polarization of light.

By performing the above compensation, it is possible to prevent light, which has passed through the liquid crystal, from entering the outgoing side polarizer in a state where the phase is shifted. Thus, for example, in the outgoing side polarizer, there is less possibility that light, which is normally not allowed to be passed, will leak, and thereby it is possible to prevent a decrease in contrast and a reduction in viewing angle range.

Furthermore, although the first and second optical compensation elements are never arranged obliquely with respect to the pair of substrates, it is possible to compensate for a light phase difference that occurs in the liquid crystal. Thus, it is suitable for miniaturization of the liquid crystal device, and the like.

Note that each of the first and second optical compensation elements may be provided on the side of the pair of substrates, from which light enters (in other words, the side of the liquid crystal, from which light enters) or may be provided on the side of the pair of substrates, from which light exits.

Note that not only the VA liquid crystal but also a TN liquid crystal, an OCB liquid crystal, or the like, may also be effectively compensated by appropriately setting the relationship between the first optical axis of the first optical compensation element and the phase retardation axis of the second optical compensation element.

As described above, the liquid crystal device according to at least one embodiment is able to compensate for a phase difference that occurs in the liquid crystal by means of the first and second optical compensation elements. Thus, the liquid crystal device is able to display a relatively high-contrast and high-quality image and is also suitable for miniaturization.

In the liquid crystal device according to at least one embodiment, the second optical compensation element may include (i) a predetermined substrate and (ii) an inorganic film that is formed on the predetermined substrate and that is formed in such a manner that an inorganic material is supplied in a direction oblique to a substrate plane of the predetermined substrate.

According to the above aspect, the second optical compensation element includes (i) the predetermined substrate and (ii) the inorganic film that is formed on the predetermined substrate and that is formed in such a manner that an inorganic material is supplied in a direction oblique to the substrate plane of the predetermined substrate. The inorganic film is formed on the substrate plane in such a manner that an inorganic material, such as Ta2O5, is supplied in a direction oblique to the substrate plane of the substrate. More specifically, a method of forming the inorganic film may employ, for example, an oblique vapor deposition method or a sputtering method in which an inorganic material is supplied at an atomic level in the oblique direction. The inorganic film, when viewed microscopically, has a film structure in which an inorganic material is deposited in the oblique direction. According to the above inorganic film, the anisotropy of refractive index occurs in accordance with the film structure of the inorganic film, so that it is possible to compensate for the phase of light that enters the retardation film.

In this manner, it is possible to effectively prevent degradation of the second optical compensation element due to irradiation of light and a following increase in temperature and, hence, it is possible to form a reliable liquid crystal device.

In the liquid crystal device according to at least one embodiment, the second optical compensation element may have a negative biaxial index ellipsoid as the negative index ellipsoid.

According to the above aspect, the negative index ellipsoid is inclined with respect to one plane, so that it is possible to appropriately and easily cause a phase retardation axis to occur.

At least one embodiment of the disclosure provides a liquid crystal device. The liquid crystal device includes a pair of substrates, a liquid crystal, a pair of polarizers, a first optical compensation element, and a second optical compensation element. The pair of substrates are arranged so as to face each other. An alignment layer is provided for each of the pair of substrates. The liquid crystal is held between the pair of substrates and is formed of liquid crystal molecules that are pretilted by the alignment layers. The pair of polarizers are arranged so as to place the pair of substrates in between. The first optical compensation element is arranged between the pair of polarizers. The first optical compensation element has a positive uniaxiality and has a first optical axis, as an optical axis, that is inclined in a direction different from a direction in which major axes of the pretilted liquid crystal molecules incline with respect to one plane that is oriented along the pair of substrates. The second optical compensation element is arranged between the pair of polarizers. The second optical compensation element has a biaxial index ellipsoid and has a phase retardation axis that is rotatable about an axis that is oriented along the normal line of the one plane.

According to the liquid crystal device of at least one embodiment, the pair of substrates are arranged so as to face each other, and the liquid crystal is held between the pair of substrates. The liquid crystal is typically a vertical alignment liquid crystal, that is, a VA liquid crystal. The alignment layer is provided for each of the pair of substrates. The alignment layers pretilt the liquid crystal molecules, which constitute the liquid crystal, so as to be raised at a predetermined angle in a predetermined direction. For example, when the liquid crystal is a VA liquid crystal, the liquid crystal molecules are aligned so that they are inclined at a pretilt angle in a predetermined direction with respect to the normal line of the one plane that is oriented along the pair of substrates. For example, when the liquid crystal is a TN liquid crystal, the liquid crystal molecules are aligned so that they are inclined at a pretilt angle in a predetermined direction with respect to the one plane that is oriented along the pair of substrates. The above alignment layers each are typically an organic alignment layer on which rubbing is performed in a predetermined direction. Alternatively, the alignment layers each may be an inorganic alignment layer. The pair of substrates between which the liquid crystal is held is arranged so as to be placed between the pair of polarizers. When the liquid crystal device is operating, light, such as projection light, enters the liquid crystal device and then the liquid crystal device serves as a liquid crystal light bulb.

In at least one embodiment, particularly, the first and second optical compensation elements are provided. Each of the first and second optical compensation elements is arranged between the pair of polarizers. More specifically, each of the first and second optical compensation elements is arranged between the pair of substrates and one of the pair of polarizers or between the pair of substrates and the other of the pair of polarizers. In other words, each of the first and second optical compensation elements is provided between the pair of polarizers and on the side of the pair of substrates, from which light enters or from which light exits. The first optical compensation element has a positive uniaxiality and, for example, includes a positive uniaxial crystal. The first optical axis, which is the optical axis of the first optical compensation element, is inclined in a direction different from a direction in which the major axes of the pretilted liquid crystal molecules incline with respect to the one plane that is oriented along the pair of substrates. That is, the direction in which the first optical axis is inclined with respect to the one plane that is oriented along the pair of substrates is different from the direction in which the major axes of the liquid crystal molecules incline with respect to the one plane that is oriented along the pair of substrates at portions that contact the alignment layers at the time when the liquid crystal device is not operating. For example, when the liquid crystal is a VA liquid crystal, the first optical axis is typically oriented along a direction that is symmetrical with the major axes of the pretilted liquid crystal molecules with respect to the one plane that is oriented along the pair of substrates. The second optical compensation element has the biaxial index ellipsoid and has the phase retardation axis that is rotatable about an axis that is oriented along the normal line of the one plane. Here, the phase retardation axis according to the aspects of the disclosure means a direction in which the refractive index is maximal in one plane (in other words, a direction in which speed of light is minimal). Thus, for example, the second optical compensation element may be adjusted by rotation so as to cancel a light phase difference that occurs because of the liquid crystal and the first optical compensation element or so as to be able to minutely adjust the state of polarization of light.

Thus, for example, when the liquid crystal device, which serves as a liquid crystal light bulb, is operating, it is possible for the first and second optical compensation elements to compensate for a light phase difference that occurs when incident light passes through the liquid crystal formed of the liquid crystal molecules that are inclined with respect to the pair of substrates. In short, the first optical compensation element, which has the first optical axis that is inclined in a direction different from a direction in which the major axes of the liquid crystal molecules incline, is arranged for the liquid crystal that is formed of the pretilted liquid crystal molecules, so that the index ellipsoid that indicates the anisotropy of overall refractive index of a set of the liquid crystal and the first optical compensation element is approximated to a biaxial index ellipsoid. Thus, it is possible for the first optical compensation element to compensate for a phase difference that occurs from a state in which the major axes of the pretilted liquid crystal molecules are inclined with respect to the normal line of the one plane that is oriented along the pair of substrates. Furthermore, the second optical compensation element, which has the biaxial index ellipsoid and has the phase retardation axis that is rotatable about an axis that is oriented along the normal line of the one plane, is arranged for the liquid crystal and the first optical compensation element. The second optical compensation element is, for example, adjusted by rotation so as to cancel a light phase difference that occurs because of the liquid crystal and the first optical compensation element, so that it is possible to reduce the anisotropy of overall refractive index of a set of the liquid crystal and the first and second optical compensation elements. In addition, the second optical compensation element also serves to minutely adjust the state of polarization of light.

By performing the above compensation, it is possible to prevent light, which has passed through the liquid crystal, from entering the outgoing side polarizer in a state where the phase is shifted. Thus, for example, in the outgoing side polarizer, there is less possibility that light, which is normally not allowed to be passed, will leak, and thereby it is possible to prevent a decrease in contrast and a reduction in viewing angle range.

Furthermore, although the first and second optical compensation elements are never arranged obliquely with respect to the pair of substrates, it is possible to compensate for a light phase difference that occurs in the liquid crystal. Thus, it is suitable for miniaturization of the liquid crystal device, and the like.

Note that each of the first and second optical compensation elements may be provided on the side of the pair of substrates, from which light enters (in other words, the side of the liquid crystal, from which light enters) or may be provided on the side of the pair of substrates, from which light exits.

Note that not only the VA liquid crystal but also a TN liquid crystal, an OCB liquid crystal, or the like, may also be effectively compensated by appropriately setting the relationship between the first optical axis of the first optical compensation element and the phase retardation axis of the second optical compensation element.

As described above, the liquid crystal device according to at least one embodiment is able to compensate for a phase difference that occurs in the liquid crystal by means of the first and second optical compensation elements. Thus, the liquid crystal device is able to display a relatively high-contrast and high-quality image and is also suitable for miniaturization.

In the liquid crystal device according to at least one embodiment, the direction of a maximum main refractive index among three main refractive indices in the index ellipsoid may be oriented along the one plane.

According to the above aspect, it is possible to maximize a component of the phase retardation axis, which is projected onto the one plane, in the biaxial index ellipsoid. In this manner, it is possible for the second optical compensation element to; for example, effectively cancel a light phase difference that occurs because of the liquid crystal and the first optical compensation element.

In the liquid crystal device according to at least one embodiment, the second optical compensation element may be formed of a birefringent polymer and may be a drawn optical film.

According to the above aspect, by means of the above optical film, it is possible to easily create the second optical compensation element to which the phase retardation axis is set appropriately.

In the liquid crystal device according to at least one embodiment, the second optical compensation element may be adjusted by rotation so as to adjust that the state of polarization of light that exits from one of the polarizers arranged on a side of the pair of substrates, from which light enters, from a state in which the direction of a maximum main refractive index among three main refractive indices in the index ellipsoid is oriented along the polarization axis of one of the pair of polarizers.

According to the above aspect, the second optical compensation element is configured so that the direction of the maximum main refractive index of the second optical compensation element is oriented along the polarization axis of the incident side polarizer or the outgoing side polarizer, and then the second optical compensation element is, for example, adjusted by rotation by means of a rotation adjusting device that is provided outside the liquid crystal device so as to adjust the state of polarization of light that exits from the incident side polarizer. Thus, the state of polarization of light is adjusted by the second optical compensation element, so that it is possible to allow light to enter the outgoing side polarizer in a further appropriate state of polarization. Thus, it is possible to display a further high-quality image.

In the liquid crystal device according to at least one embodiment, the liquid crystal may be a vertical alignment liquid crystal.

According to the above aspect, the liquid crystal molecules are aligned vertically, and the pretilt angles that are given to the liquid crystal molecules by both alignment layers provided respectively for the pair of substrates are the same. Thus, it is possible for the first and second optical compensation elements to effectively compensate for a light phase difference that occurs from a state in which the major axes of the liquid crystal molecules that are pretilted by the two alignment layers are inclined with respect to the normal line of the one plane.

In the aspect in which the above described liquid crystal is a vertical alignment liquid crystal, an angle at which the first optical axis makes with respect to the normal line of the one plane may be equal to a pretilt angle that is an angle at which the major axes of the pretilted liquid crystal molecules make with respect to the normal line of the one plane.

In this case, because the angle at which the first optical axis is inclined with respect to the normal line of the one plane that is oriented along the pair of substrates (that is, the angle at which the first optical axis makes with the normal line) is equal to the pretilt angle, it is possible to effectively compensate for a light phase difference that occurs from a state in which the major axes of the liquid crystal molecules are inclined with respect to the normal line of the one plane. Here, the wording “the inclined angle of the first optical axis is equal to the pretilt angle” means that the inclined angle is approximate to the pretilt angle within a range that is sufficient to compensate for a light phase difference that occurs from a state in which the major axes of the liquid crystal molecules are inclined, to a degree that is allowed on the basis of product specification, that is, it includes not only the case in which the inclined angle is literally equal to the pretilt angle pretilt angle but also the case in which the inclined angle is substantially equal to the pretilt angle.

In the liquid crystal device according to at least one embodiment, the first optical compensation element may be formed of a crystal plate that includes a positive uniaxial crystal and that is formed by polishing so that an optical axis of the crystal plate is inclined with respect to one surface.

According to the above aspect, the first optical compensation element may be relatively easily formed as a crystal plate that has an optical axis that is inclined with respect to the one plane that is oriented along the pair of substrates. Thus, it is not necessary to arrange the first optical compensation element so as to be inclined with respect to the one plane, so that it is possible to achieve miniaturization of the liquid crystal device. Here, the wording “one surface” according to the aspects of the disclosure means one of main faces included in a plate-like crystal plate. Note that, when a rock crystal is used as a positive uniaxial crystal, for example, it is low in cost and easy in working on a crystal plate as compared with the case in which a sapphire, or the like, is used. Thus, it is possible to reduce costs.

The crystal plate, of which the optical axis is inclined with respect to one surface, may be formed in such a manner that, for example, a crystal is cut along a line that is inclined at a predetermined angle with respect to the optical axis of the crystal and then polished so as to have a predetermined thickness. Note that it is desirable that a face on the opposite side to the one surface is polished so as to be parallel to the one surface.

In the liquid crystal device according to at least one embodiment, a third optical compensation element that has a negative uniaxiality and that has a third optical axis, as an optical axis, that is oriented along the direction of the normal line of the one plane may be further provided.

According to the above aspect, the third optical compensation element is, for example, formed of a negative uniaxial retardation film (that is, C plate), and the third optical compensation element is arranged so as to face the pair of substrates so that the third optical axis, which is the optical axis of the third optical compensation element, is oriented along the direction of the normal line of the one plane that is oriented along the pair of substrates. Thus, it is possible to further reliably compensate for a light phase difference that occurs when passing through the liquid crystal. In other words, it is possible for the first, second and third optical compensation elements to further reduce the anisotropy of overall refractive index of a set of the liquid crystal held between the pair of substrates and the first, second and third optical compensation elements. That is, it is possible to further approximate the index ellipsoid, which indicates the anisotropy of overall refractive index of a set of the liquid crystal and the first, second and third optical compensation elements, to a sphere. Thus, it is possible to further reliably prevent a decrease in contrast and a reduction in viewing angle range.

In the aspect in which the above described third optical compensation element is provided, the third optical compensation element may be formed of an inorganic material.

In this case, the third optical compensation element is, for example, formed of an inorganic material using a vapor deposition method, or the like. Thus, the third optical compensation element substantially or completely does not exhibit degradation due to ultraviolet light, or the like. Thus, it is possible to improve the light fastness and/or durability of the third optical compensation element and, hence, it is possible to reduce or prevent degradation of quality over time in a display image.

In the aspect in which the above described third optical compensation element is provided, a microlens array that is arranged on a side of the pair of substrates, from which light enters, may be further provided, and the third optical compensation element may be provided on a side of the pair of substrates, from which light exits.

In this case, because the third optical compensation element may be arranged on a side of the microlens array, from which light exits, it is possible for the third optical compensation element to reliably compensate for a phase difference that occurs when light refracted by the microlens array passes through the liquid crystal. In other words, it is possible to substantially or completely eliminate an adverse effect due to a light phase shift caused by the microlens array.

In the liquid crystal device according to at least one embodiment, the first and second optical compensation elements may be provided on a side of the pair of substrates, from which light exits.

According to the above aspect, because the first and second optical compensation elements may be, for example, arranged on a side of the microlens array, from which light exits, it is possible for the first and second optical compensation elements to reliably compensate for a phase difference that occurs when light refracted by the microlens array passes through the liquid crystal. In other words, it is possible to substantially or completely eliminate an adverse effect based on a light phase shift caused by the microlens array.

In the liquid crystal device according to at least one embodiment, the second optical compensation element may be adjusted by rotation so as to cancel a light phase difference that occurs because of the liquid crystal and the first optical compensation element.

According to the above aspect, the second optical compensation element is adjusted by rotation so as to cancel a light phase difference that occurs because of the liquid crystal and the first optical compensation element, for example, by means of a rotation adjusting device that is provided outside the liquid crystal device. Thus, it is possible to further reduce the anisotropy of overall refractive index of a set of the liquid crystal and the first and second optical compensation elements.

In the liquid crystal device according to at least one embodiment, the second optical compensation element may be adjusted by rotation so as to adjust the state of polarization of light that exits from one of the pair of polarizers arranged on a side of the pair of substrates, from which light enters, from a state in which the phase retardation axis is oriented along the polarization axis of any one of the pair of polarizers.

According to the above aspect, the second optical compensation element is configured so that the phase retardation axis of the second optical compensation element is oriented along the polarization axis of the incident side or outgoing side polarizer, and then the second optical compensation element is, for example, adjusted by rotation by means of a rotation adjusting device that is provided outside the liquid crystal device so as to adjust the state of polarization of light that exits from the incident side polarizer. Thus, the state of polarization of light is adjusted by the second optical compensation element, so that it is possible to allow light to enter the outgoing side polarizer in a further appropriate state of polarization. Thus, it is possible to display a further high-quality image.

In the liquid crystal device according to at least one embodiment, the second optical compensation element may be provided on a side of the pair of substrates, from which light enters.

According to the above aspect, when the liquid crystal device is, for example, provided in a projector as a light bulb, the second optical compensation element may be easily adjusted by rotation so that it does not substantially or completely contact other members.

Another embodiment provides an electronic apparatus that includes the liquid crystal device according to at least one of the described embodiments.

Because the electronic apparatus according to the aspects of the disclosure includes the liquid crystal device according to the above described embodiment, it is possible to compensate for a phase difference that occurs in light that passes through the liquid crystal layer, so that it is possible to achieve a high contrast. As a result, it is possible to implement various electronic apparatuses, such as a projection display device, a television, a cellular phone, a personal organizer, a word processor, a viewfinder type or a direct view type video tape recorder, a workstation, a video telephone, a POS terminal, or a touch panel, that performs high-quality image display and is suitable for miniaturization.

The nature, availability and further characteristics of the various aspects of the disclosed embodiments will become apparent from the following description in connection with various embodiments of the disclosure with reference to the accompanying drawings that are briefly described below.

### BRIEF DESCRIPTION OF THE DRAWINGS

Various embodiments of the disclosure are described with reference to the accompanying drawings, wherein like reference numbers designate like elements.

FIG. 1 is a plan view of a liquid crystal display panel according to one embodiment of the present disclosure.

FIG. 2 is a cross-sectional view that is taken along the line II-II in FIG. 1.

FIG. 3 is a cross-sectional view of a liquid crystal device according to one embodiment of the present disclosure.

FIG. 4 is a perspective view of a first optical compensation element and a second optical compensation element according to one embodiment of the present disclosure.

FIG. 5A and FIG. 5B are conceptional views that show a method of forming the first optical compensation element according to one embodiment of the present disclosure.

FIG. 6 is a conceptional view that conceptionally shows a composite estimated index ellipsoid resulting from the estimated index ellipsoid of a liquid crystal layer and the estimated index ellipsoid of the first optical compensation element.

FIG. 7 is a cross-sectional view of a liquid crystal device, similar to FIG. 3 of the first embodiment, according to a second embodiment of the present disclosure.

FIG. 8 is a perspective view of a first optical compensation element and a second optical compensation element, similar to FIG. 4 of the first embodiment, according to the second embodiment.

FIG. 9 is an example of the measured result of the contrast of a display image that is displayed by the liquid crystal device according to the first embodiment and the second embodiment of the present disclosure.

FIG. 10 is a cross-sectional view of a liquid crystal device according to a third embodiment of the present disclosure.

FIG. 11 is a perspective view of a first optical compensation element, a second optical compensation element and polarizers according to the third embodiment.

FIG. 12 is a cross-sectional view of a liquid crystal device, similar to FIG. 10 of the third embodiment, according to a fourth embodiment of the present disclosure.

FIG. 13 is a perspective view of a first optical compensation element, a second optical compensation element and polarizers, similar to FIG. 11 of the third embodiment, according to the fourth embodiment.

FIG. 14 is a cross-sectional view of a liquid crystal device, similar to FIG. 3 of the first embodiment, according to a fifth embodiment of the present disclosure.

FIG. 15A is a viewing angle range characteristic chart of the liquid crystal device according to the third embodiment.

FIG. 15B is a viewing angle range characteristic chart of the liquid crystal device according to the fourth embodiment.

FIG. 15C is a viewing angle range characteristic chart of a liquid crystal device according to a first comparative example.

FIG. 15D is a viewing angle range characteristic chart of a liquid crystal device according to a second comparative example.

FIG. 16 is a cross-sectional view of a liquid crystal device according to a sixth embodiment of the present disclosure.

FIG. 17 is a perspective view of a first optical compensation element, a second optical compensation element and polarizers according to the sixth embodiment.

FIG. 18A is an outside perspective view that schematically shows the positional relationship between a negative biaxial index ellipsoid and the substrate plane (that is, XY-plane) of a TFT array substrate according to the sixth embodiment.

FIG. 18B is a plan view that schematically shows the positional relationship between the negative biaxial index ellipsoid and the substrate plane of the TFT array substrate.

FIG. 19 is a cross-sectional view that shows the configuration of the second optical compensation element according to the sixth embodiment.

FIG. 20 is a cross-sectional view of a liquid crystal device, similar to FIG. 16 of the sixth embodiment, according to a seventh embodiment of the present disclosure.

FIG. 21 is a perspective view of a first optical compensation element, a second optical compensation element and polarizers, similar to FIG. 17 of the sixth embodiment, according to the seventh embodiment.

FIG. 22 is a graph that shows the quantitative relationship between an angle θ2 of the first optical compensation element and a variation in contrast in accordance with the angle θ2 when the second optical compensation element according to the seventh embodiment is used and when an optical film according to a comparative example is used.

FIG. 23A is a graph that shows the quantitative relationship between the contrast of the seventh embodiment and the contrast of the comparative example.

FIG. 23B is a viewing angle range characteristic chart of the liquid crystal device according to the comparative example.

FIG. 23C is a viewing angle range characteristic chart of the liquid crystal device according to the seventh embodiment.

FIG. 24 is a cross-sectional view of a liquid crystal device, similar to FIG. 3 of the first embodiment, according to an eighth embodiment of the present disclosure.

FIG. 25 is a cross-sectional view of a liquid crystal device according to a ninth embodiment of the present disclosure.

FIG. 26 is a perspective view of a first optical compensation element, a second optical compensation element and polarizers according to the ninth embodiment.

FIG. 27A is an outside perspective view that schematically shows the positional relationship between a biaxial optical anisotropy and the substrate plane (that is, XY-plane) of a TFT array substrate according to the ninth embodiment.

FIG. 27B is a plan view that schematically shows the positional relationship between the biaxial optical anisotropy and the substrate plane of the TFT array substrate.

FIG. 27C is a cross-sectional view that is taken along the line XXVIIC-XXVIIC in FIG. 27B.

FIG. 28A is a graph that shows the quantitative relationship between the contrast of the ninth embodiment and the contrast of the comparative example.

FIG. 28B is a viewing angle range characteristic chart of the liquid crystal device according to the comparative example.

FIG. 28C is a viewing angle range characteristic chart of the liquid crystal device according to the ninth embodiment.

FIG. 29 is a plan view that shows the configuration of a projector, which is one example of an electronic apparatus according to the aspects of the disclosure.

### DESCRIPTION OF EXEMPLARY EMBODIMENTS

In the following description, reference is made to the accompanying drawings which form a part hereof wherein like numerals designate like parts throughout, and in which are shown, by way of illustration, specific embodiments in which the disclosure may be practiced. It is to be understood that other embodiments may be utilized and structural or logical changes may be made without departing from the scope of the present disclosure. Therefore, the following description is not to be taken in a limiting sense, and the scope of the present disclosure is defined by the appended claims and their equivalents.

Throughout the specification and claims, the following terms take at least the meanings explicitly associated herein, unless the context clearly dictates otherwise. The meanings identified below are not intended to limit the terms, but merely provide illustrative examples for use of the terms. The meaning of “a,” “an,” and “the” may include reference to both the singular and the plural. Reference in the specification to “one embodiment” or “an embodiment” means that a particular feature, structure, or characteristic described in connection with the embodiment is included in at least one embodiment of the disclosure. The meaning of “in” may include “in” and “on.” The appearances of the phrases “in one embodiment” or “in an embodiment” in various places in the specification do not necessarily all refer to the same embodiment, but it may.

Various embodiments of the disclosure will be described with reference to the accompanying drawings. Several embodiments will sequentially be described under corresponding section headings below. Section headings are merely employed to improve readability, and they are not to be construed to restrict or narrow the present disclosure. For example, the order of description headings should not necessarily be construed so as to imply that these operations are necessarily order dependent or to imply the relative importance of an embodiment. Moreover, the scope of a disclosure under one section heading should not be construed to restrict or to limit the disclosure to that particular embodiment, rather the disclosure should indicate that a particular feature, structure, or characteristic described in connection with a section heading is included in at least one embodiment of the disclosure, but it may also be used in connection with other embodiments.

### First Embodiment

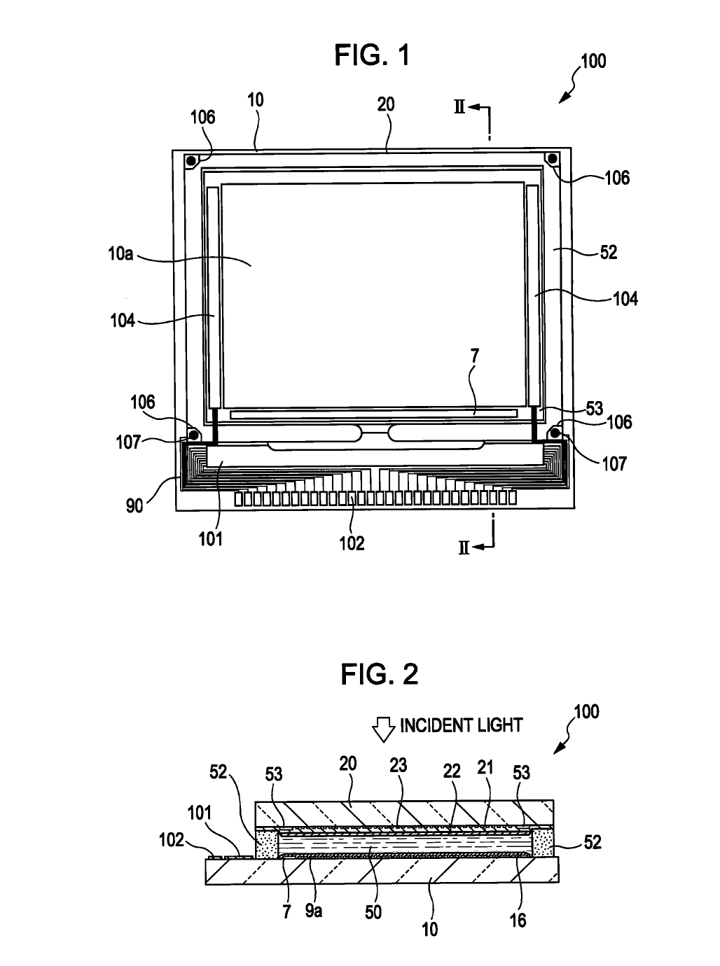

First, a liquid crystal display panel that constitutes a liquid crystal device according to a first embodiment will be described with reference to FIG. 1 and FIG. 2. The liquid crystal device according to the present embodiment is a liquid crystal device that is used for the light bulb of a projection display, such as a liquid crystal projector. Here, FIG. 1 is a plan view that shows the configuration of the liquid crystal display panel according to the present embodiment. FIG. 2 is a cross-sectional view that is taken along the line II-II in FIG. 1. Note that, in FIG. 1 and FIG. 2, an optical compensation element, which will be described later in detail, is not arranged, and only the liquid crystal display panel is shown.

As shown in FIG. 1 and FIG. 2, in the liquid crystal display panel 100 that constitutes the liquid crystal device according to the present embodiment, a TFT array substrate 10 and an opposite substrate 20, which serve as an example of a pair of substrates according to the aspects of the disclosure, are arranged so as to face each other. A liquid crystal layer 50 is sealed between the TFT array substrate 10 and the opposite substrate 20. The TFT array substrate 10 and the opposite substrate 20 are bonded to each other by means of a seal material 52, which is provided at a seal region that is positioned around an image display area 10a.

In FIG. 1, in parallel to the inside of the seal region in which the seal material 52 is arranged, a window-frame-shaped light shielding film 53, having a light shielding property, that defines a window frame region of the image display area 10a is provided on the side of the opposite substrate 20. Within a peripheral region, in a region located on the outer side of the seal region in which the seal material 52 is arranged, a data line driving circuit 101 and an external circuit connecting terminal 102 are provided along one side of the TFT array substrate 10. In a region located inside the seal region along the one side, a sampling circuit 7 is provided so as to be covered with the window-frame-shaped light shielding film 53. Scanning line driving circuits 104 are provided inside the seal region along two sides, adjacent to the one side so as to be covered with the window-frame-shaped light shielding film 53. On the TFT array substrate 10, conductive terminals 106 are arranged at regions that are opposed to four corner portions of the opposite substrate 20 in order to connect both substrates using conductive materials 107. In this manner, electrical conduction is established between the TFT array substrate 10 and the opposite substrate 20.

On the TFT array substrate 10, a routed wiring 90 is formed to electrically connect the external circuit connecting terminal 102 with the data line driving circuit 101, the scanning line driving circuits 104, the conductive terminals 106, and the like.

In FIG. 2, a laminated structure in which pixel switching TFTs (Thin Film Transistors) and wirings, such as scanning lines, data lines, and the like, are formed is formed on the TFT array substrate 10. In the image display area 10a, pixel electrodes 9a are provided in a matrix in the upper layer on the pixel switching TFTs and the wirings, such as the scanning lines and the data lines. An alignment layer 16 is formed on the pixel electrodes 9a. On the other hand, a light shielding film 23 is formed on a face of the opposite substrate 20, opposite the TFT array substrate 10. The light shielding film 23 is, for example, formed of a light shielding metal film, or the like, and is patterned, for example, in a grid, or the like, in the image display area 10a on the opposite substrate 20. Then, an opposite electrode 21, which is formed of a transparent material, such as ITO (Indium Tin Oxide), is formed, for example, in a solid manner on the light shielding film 23 so as to be opposed to the plurality of pixel electrodes 9a. An alignment layer 22 is formed on the opposite electrode 21. The liquid crystal layer 50 is configured to include liquid crystal molecules of which the anisotropy of dielectric constant is negative. Thus, the liquid crystal device according to the present embodiment is a liquid crystal device in which alignment of liquid crystal molecules is controlled in a vertical alignment (VA) mode. Note that the liquid crystal device according to the aspects of the disclosure is not limited to the liquid crystal device that has liquid crystal molecules of which the anisotropy of dielectric constant is negative; however, it may be a liquid crystal device that has, for example, a liquid crystal mixed with one or a few kinds of nematic liquid crystals and that is placed in a predetermined alignment state between the pair of alignment layers 16 and 22.

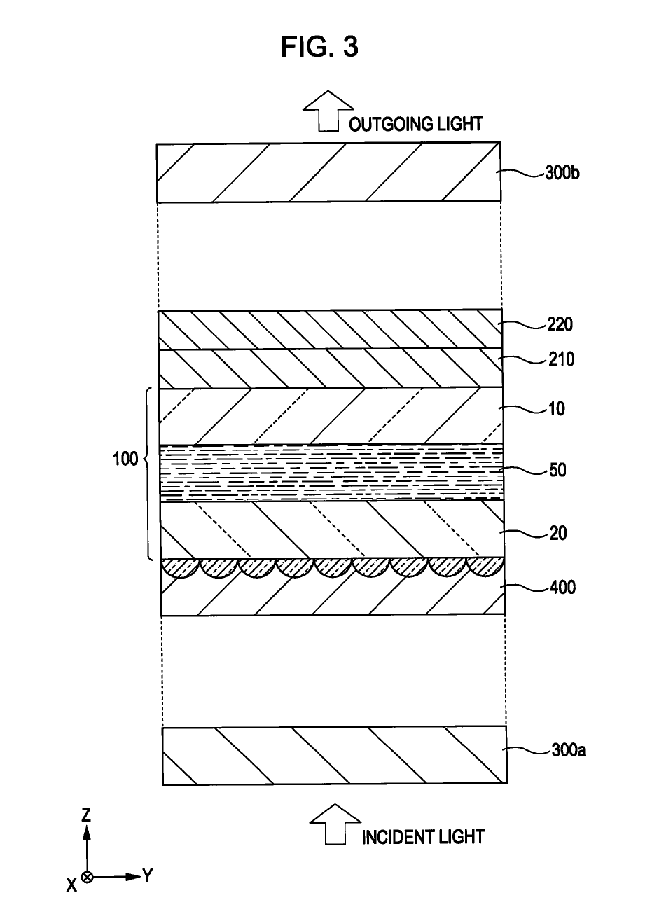

Although not shown in the drawing, a microlens array 400, which will be described later with reference to FIG. 3, is provided on a face (that is, face on a side from which incident light enters) opposite to a side that faces the liquid crystal layer 50 in the opposite substrate 20.

Although not described in the drawing, in addition to the data line driving circuit 101 and the scanning line driving circuits 104, a check circuit, a checking pattern, or the like, for checking the quality, defects, or the like, of the liquid crystal device during manufacturing or upon shipment, or the like, may be formed on the TFT array substrate 10.

Next, first and second optical compensation elements of the liquid crystal device according to the present embodiment will be described with reference to FIG. 3 to FIG. 6.

First, positions at which the first and second optical compensation elements are arranged will be described with reference to FIG. 3. Here, FIG. 3 is a cross-sectional view of the liquid crystal device according to the present embodiment, showing the configuration of the liquid crystal device and the incident direction in which incident light enters the liquid crystal device according to the present embodiment. Note that, in the following drawings, among the components shown in FIG. 1 and FIG. 2, the detailed components of the liquid crystal display panel 100 will be omitted appropriately and only the components that are directly relevant will be shown. In addition, for the sake of convenience, FIG. 3 is a view that is obtained by turning the TFT array substrate 10 and the opposite substrate 20, shown in FIG. 2, upside down.

As shown in FIG. 3, the liquid crystal device according to the present embodiment includes the liquid crystal display panel 100, the microlens array 400, a first optical compensation element 210, and a second optical compensation element 220, which are arranged so as to be held between polarizers 300a and 300b.

The microlens array 400 is a microlens array plate in which microlenses corresponding to pixels of the liquid crystal display panel 100 are formed. The microlens array 400 is provided between the incident side polarizer 300a, which is provided on the incident side, and the liquid crystal display panel 100. Owing to the microlens array 400, incident light may be collected in units of pixels, and an actual aperture ratio of the liquid crystal display panel 100 may be improved. That is, owing to the microlens array 400, the usability of light, brightness, and color purity in the liquid crystal display panel 100 may be improved.

The first optical compensation element 210 and the second optical compensation element 220 are provided between the outgoing side polarizer 300b, which is provided on the outgoing side, and the liquid crystal display panel 100. The first optical compensation element 210 and the second optical compensation element 220 are adhered to the TFT array substrate 10 in the stated order. Note that each of the first optical compensation element 210 and the second optical compensation element 220 may be provided with a support body other than the TFT array substrate 10 and then may be integrated with the support body.

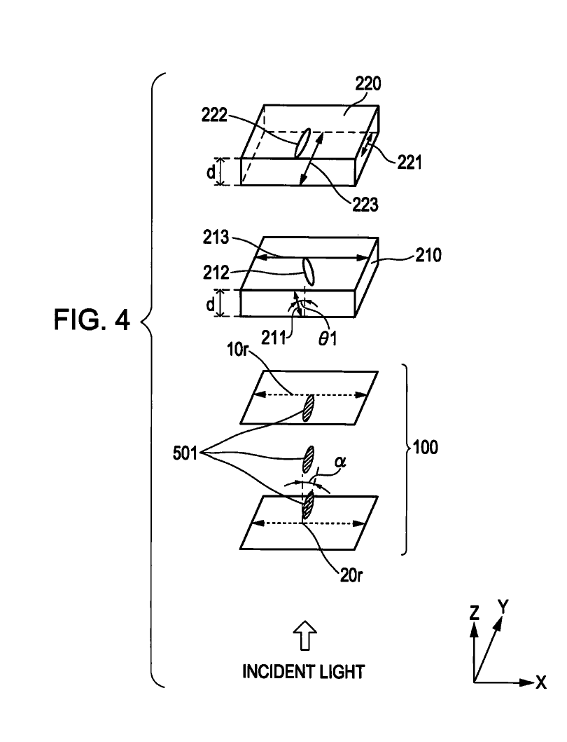

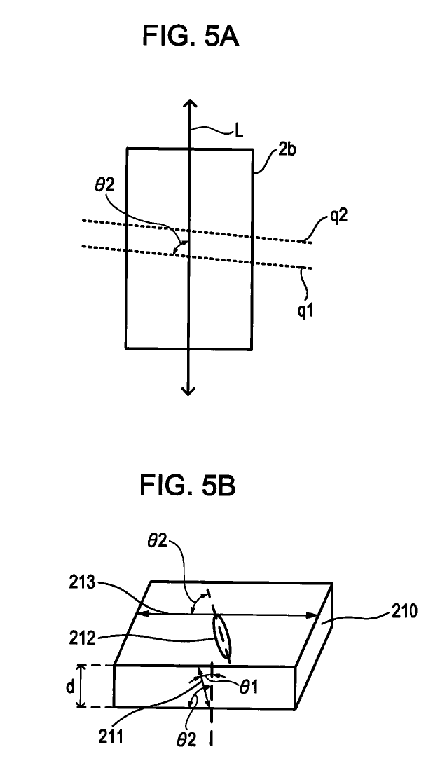

Next, the configuration of the first and second optical compensation elements will be described with reference to FIG. 4 and FIG. 5. Here, FIG. 4 is a perspective view of the first optical compensation element and the second optical compensation element according to the present embodiment. FIG. 5A and FIG. 5B are conceptional views that show a method of forming the first optical compensation element according to the present embodiment. Note that, in FIG. 4, in addition to the first and second optical compensation elements, the status of liquid crystal molecules in the liquid crystal display panel 100, when no voltage is applied, is conceptionally shown. In addition, in FIG. 4, for the sake of convenience, an angle α and an angle θ1 are shown so as to be larger than the actual angles.

In FIG. 4, liquid crystal molecules 501 in the liquid crystal layer 50, when no voltage is applied, are pretilted by the alignment layers 22 and 16 (see FIG. 2) within the plane of the opposite substrate 20 (or the TFT array substrate 10) at a predetermined angle from the plane in a predetermined direction (in a direction along a tilt direction 20r of the liquid crystal located adjacent to the alignment layer 22 (that is, a tilt direction 10r of the liquid crystal located adjacent to the alignment layer 16), which extends in a direction along an X direction in FIG. 4), and are aligned obliquely by a pretilt angle α with respect to the normal line of the opposite substrate 20 (or the TFT array substrate 10).

The first optical compensation element 210 is, for example, formed of a crystal plate that is formed from positive uniaxial crystals, such as rock crystal. The optical axis 211 of the first optical compensation element 210 is inclined in a direction that is different from a direction, in which the major axes of the liquid crystal molecules 501 incline, with respect to the plane of the first optical compensation element 210, which faces the liquid crystal display panel 100 (that is, XY-plane). That is, for example, when viewed within one plane that is perpendicular to the TFT array substrate 10 along the tilt direction 10r, the optical axis 211 is inclined with respect to the normal line of the TFT array substrate 10 (that is, Z-axis) at an angle θ1 in a direction that is different from a direction in which the major axes of the liquid crystal molecules 501 incline. Thus, an estimated index ellipsoid 212 is also inclined at an angle θ1 with respect to the normal line of the TFT array substrate 10 in a direction that is different from a direction in which the major axes of the liquid crystal molecules 501 incline. A phase retardation axis 213 of the first optical compensation element 210 is oriented along the tilt direction 10r of the liquid crystal located adjacent to the alignment layer 16 (that is, the tilt direction 20r of the liquid crystal located adjacent to the alignment layer 22 or the X direction). More specifically, a first optical axis 211 is oriented along a direction that is symmetrical with the major axes of the pretilted liquid crystal molecules 501 with respect to the plane of the first optical compensation element 210, which faces the liquid crystal display panel 100 (that is, XY-plane), and the angle θ1 is set so as to be substantially or practically completely equal to the pretilt angle α.

As shown in FIG. 5A, in the present embodiment, a positive uniaxial crystal 2b is cut along cutting plane lines q1 and q2 that are inclined at an angle θ2 (here, the angle θ2 is a difference between 90 degrees and the angle θ1) with respect to an optical axis L, and is then polished so as to have a predetermined thickness d. Thus, the first optical compensation element 210, as shown in FIG. 5B, is formed. According to the above forming method, for example, when the angle θ2 is set to 85 degrees, it is easy to form the first optical compensation element 210 of which the angle θ1 is 5 degrees (that is, the angle substantially equal to the pretilt angle α). Note that the polishing may employ various polishing technique, such as CMP (Chemical Mechanical Polishing), for example.

Referring back to FIG. 4, the second optical compensation element 220 is, for example, formed of a film organic compound that functions as a positive uniaxial retardation film (that is, A plate). The optical axis 221 of the second optical compensation element 220 is oriented along the plane of the first optical compensation element 210, which faces the liquid crystal display panel 100, (that is, XY-plane) and, when viewed in the direction of the normal line of the facing plane (that is, Z direction), intersects with the optical axis 211 of the first optical compensation element 210 at an angle of, for example, 80 degrees to 90 degrees. In other words, the optical axis 221 of the second optical compensation element 220 is oriented along the XY-plane, and, when viewed in the Z direction, intersects with the long axes of the pretilted liquid crystal molecules 510 at an angle of, for example, 80 degrees to 90 degrees. Thus, an estimated index ellipsoid 222 is also oriented along the XY-plane, and the phase retardation axis 223 of the second optical compensation element 220, when viewed in the Z direction, intersects with the phase retardation axis 213 of the first optical compensation element 210 at an angle of, for example, 80 degrees to 90 degrees.

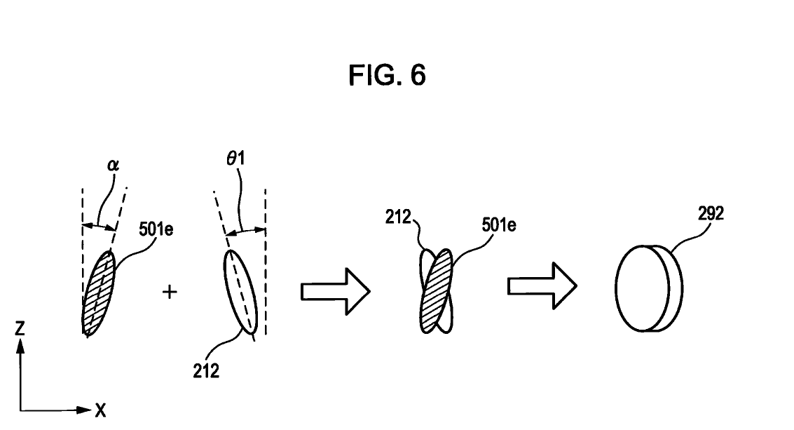

Next, the operation of the liquid crystal device that includes the above configured first and second optical compensation elements will be described with reference to FIG. 6 together with FIG. 3 and FIG. 4. Here, FIG. 6 is a conceptional view that conceptionally shows a composite estimated index ellipsoid resulting from the estimated index ellipsoid of the liquid crystal layer and the estimated index ellipsoid of the first optical compensation element.

In FIG. 3, when the liquid crystal device according to the present embodiment is operating, incident light initially enters the incident side polarizer 300a. The polarizer 300a only transmits light that oscillates in an angular direction of ideally 45 degrees with respect to a predetermined direction (in the present embodiment, the tilt direction 20r of the liquid crystal located adjacent to the alignment layer 22 provided on the opposite substrate 20, that is, X direction). That is, incident light becomes linearly polarized light after passing through the polarizer 300a. The incident light that has passed through the polarizer 300a passes through the microlens array 400 and the opposite substrate 20 and then enters the liquid crystal layer 50.

As shown in FIG. 4, the liquid crystal molecules 501 in the liquid crystal layer 50, when no voltage is applied, are aligned obliquely at the pretilt angle α in a direction along the tilt direction 10r (that is, a positive X-axis direction) with respect to the direction of the normal line of the TFT array substrate 10 (that is, Z direction). Thus, as shown in FIG. 6, an estimated index ellipsoid 501e that indicates the anisotropy of refractive index of the overall liquid crystal layer 50 is also inclined at the pretilt angle α in a direction along the tilt direction 10r (that is, the positive X-axis direction) with respect to the direction of the normal line of the TFT array substrate 10 (that is, Z direction). Therefore, if no measure is taken, light that has entered the liquid crystal layer 50 has a phase difference that occurs from a state where the estimated index ellipsoid 501e of the liquid crystal layer 50 is inclined at the pretilt angle α, so that the light that has passed through the liquid crystal layer 50 enters the outgoing side polarizer 300b in a state where the phase of the light is shifted. Note that the polarizer 300b only transmits light that oscillates in a direction that perpendicularly intersects with the polarization direction of the polarizer 300a.

Then, as shown in FIG. 4 and FIG. 6, because the liquid crystal device according to the present embodiment includes the first optical compensation element 210 and the second optical compensation element 220, it is possible to compensate for a light phase difference that occurs when incident light passes through the liquid crystal layer 50 that has the estimated index ellipsoid 501e inclined at the pretilt angle α. In other words, by means of the first optical compensation element 210 and the second optical compensation element 220, it is possible to reduce the anisotropy of overall refractive index of a set of the liquid crystal layer 50, the first optical compensation element 210 and the second optical compensation element 220. That is, it is possible to approximate the index ellipsoid, which indicates the anisotropy of overall refractive index of a set of the liquid crystal layer 50, the first optical compensation element 210 and the second optical compensation element 220, to a sphere.

In short, the first optical compensation element 210, which has the estimated index ellipsoid 212 inclined at the angle θ1 to a side opposite to that of the estimated index ellipsoid 501e, is arranged for the liquid crystal layer 50 that has the estimated index ellipsoid 501e inclined at the pretilt angle α, so that the estimated overall index ellipsoid 292 of a set of the liquid crystal layer 50 and the first optical compensation element 210 is approximated to a biaxial index ellipsoid. Thus, by means of the first optical compensation element 210, it is possible to compensate for, for example, a phase difference that occurs when light that enters along the tilt direction 10r (or 20r) passes through the liquid crystal layer 50.

Moreover, the second optical compensation element 220 that has the estimated index ellipsoid 222 that intersects with the estimated index ellipsoids 501e and 212 when viewed in the Z direction is arranged for the liquid crystal layer 50 and the first optical compensation element 210, so that the estimated overall index ellipsoid of a set of the liquid crystal layer 50, the first optical compensation element 210 and the second optical compensation element 220 is approximated to a spherical index ellipsoid. Thus, it is possible for the first optical compensation element 210 and the second optical compensation element 220 to compensate for a phase difference that occurs in the liquid crystal layer 50.

By performing the above compensation, it is possible to prevent light, which has passed through the liquid crystal layer 50, from entering the outgoing side polarizer 300b in a state where the phase is shifted. Thus, for example, in the outgoing side polarizer 300b, there is less possibility that light, which is normally not allowed to be passed, will leak, and thereby it is possible to prevent a decrease in contrast and a reduction in viewing angle range.

Furthermore, although the first optical compensation element 210 and the second optical compensation element 220 are never arranged obliquely with respect to the TFT array substrate 10 or the opposite substrate 20, it is possible to compensate for a light phase difference that occurs in the liquid crystal layer 50. Thus, it is suitable for miniaturization of the liquid crystal device, and the like.

Note that it is desirable that the retardation (Δn·d) of the first optical compensation element 210 with respect to the Z direction is substantially or completely equal to the retardation of the liquid crystal layer 50 with respect to the Z direction. In this case, it is possible to further enhance the advantageous effect in compensating for a phase difference that occurs in the liquid crystal layer 50. However, if the retardation of the first optical compensation element 210 in the Z direction is not substantially or completely equal to the retardation of the liquid crystal layer 50 in the Z direction, it is possible to appropriately enhance the advantageous effect in compensating for a phase difference that occurs in the liquid crystal layer 50 in accordance with a difference between the retardation of the first optical compensation element 210 in the Z direction and the retardation of the liquid crystal layer 50 in the Z direction. That is, for example, when the retardation of the liquid crystal layer 50 in the Z direction is 250 nm, the retardation of the first optical compensation element 210 is desirably 250 nm; however, when the retardation of the first optical compensation element 210 is, for example, within a range of 150 nm to 300 nm, it is possible to reliably enhance the advantageous effect in compensating for a phase difference that occurs in the liquid crystal layer 50.

As shown in FIG. 4, particularly in the present embodiment, the optical axis 211 of the first optical compensation element 210 intersects with the optical axis 221 of the second optical compensation element 220 at an angle of, for example, 80 degrees to 90 degrees when viewed in the direction of the normal line of the TFT array substrate 10 (that is, Z direction). Thus, for example, in comparison with the case in which the optical axis 211 is parallel to the optical axis 221 when viewed in the Z direction, it is possible to reduce the anisotropy of overall refractive index of a set of the liquid crystal layer 50, the first optical compensation element 210 and the second optical compensation element 220. Note that it is desirable that the optical axis 211 is perpendicular to the optical axis 221 when viewed in the Z direction. In this case, it is possible to further reduce the anisotropy of overall refractive index of a set of the liquid crystal layer 50, the first optical compensation element 210 and the second optical compensation element 220.

Furthermore, particularly in the present embodiment, the angle θ1 at which the optical axis 211 of the first optical compensation element 210 makes with the normal line of the TFT array substrate 10 (that is, Z-axis) is substantially or practically completely equal to the pretilt angle α at which the major axes of the pretilted liquid crystal molecules 501 make with the normal line of the TFT array substrate 10. Thus, it is possible to effectively compensate for a light phase difference that occurs from a state in which the major axes of the liquid crystal molecules 501 are inclined at the pretilt angle α with respect to the normal line of the TFT array substrate 10.

In addition, particularly in the present embodiment, the first optical compensation element 210 and the second optical compensation element 220 are provided on the side of the liquid crystal display panel 100, from which light exits. That is, the first optical compensation element 210 and the second optical compensation element 220 are arranged on the side of the microlens array 400, from which light exits. Thus, it is possible for the first optical compensation element 210 and the second optical compensation element 220 to reliably compensate for a phase difference that occurs when light that is refracted by the microlens array 400 passes through the liquid crystal layer 50. In other words, it is possible to substantially or completely eliminate an adverse effect based on a light phase difference caused by the microlens array 400. Note that the first optical compensation element 210 and the second optical compensation element 220 may be provided on the side of the liquid crystal display panel 100, from which light enters (in other words, the side of the liquid crystal layer 50, from which light enters). In this case as well, it is possible to obtain the advantageous effect in compensating for a light phase difference.

As described above, the liquid crystal device according to the present embodiment is able to compensate for a phase difference that occurs in the liquid crystal layer 50 by means of the first optical compensation element 210 and the second optical compensation element 220. Thus, the liquid crystal device is able to display a relatively high-contrast and high-quality image and is also suitable for miniaturization.

### Second Embodiment

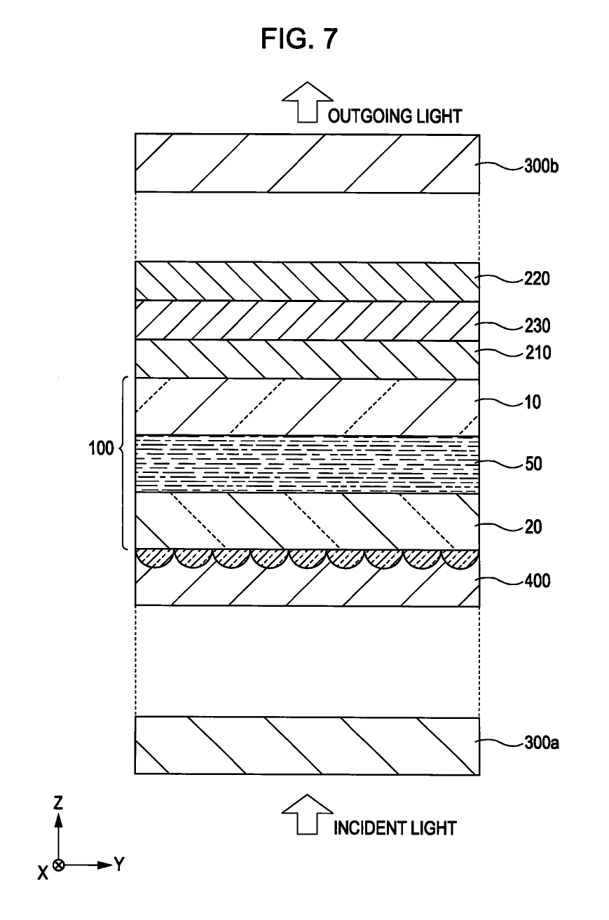

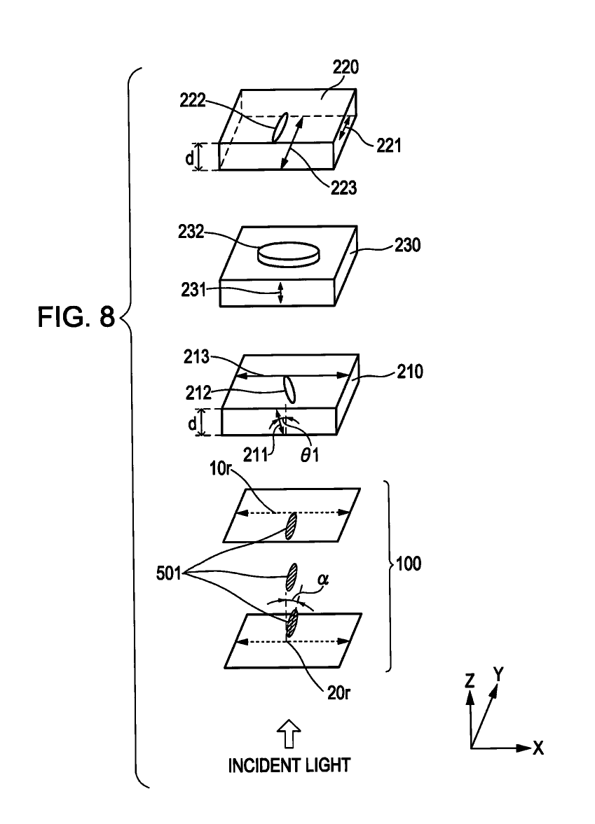

A liquid crystal device according to a second embodiment will be described with reference to FIG. 7 and FIG. 8. FIG. 7 is a cross-sectional view of the liquid crystal device, similar to FIG. 3 of the first embodiment. FIG. 8 is a perspective view of a first optical compensation element and a second optical compensation element, similar to FIG. 4 of the first embodiment. Note that, in FIG. 7 and FIG. 8, the same reference numerals are assigned to the same components as those of the first embodiment shown in FIG. 1 to FIG. 6, and the description thereof is omitted where appropriate.

As shown in FIG. 7, the liquid crystal device according to the second embodiment differs from the liquid crystal device according to the above described first embodiment in that a third optical compensation element 230 is further provided, and the portions other than the above have substantially the same configuration as those of the liquid crystal device according to the above described first embodiment.

As shown in FIG. 7, the liquid crystal device according to the second embodiment includes the liquid crystal display panel 100, the microlens array 400, the first optical compensation element 210, the second optical compensation element 220, and the third optical compensation element 230, which are arranged so as to be held between the polarizers 300a and 300b.

The third optical compensation element 230 is provided between the outgoing side polarizer 300b and the liquid crystal display panel 100 (more specifically, between the first optical compensation element 210 and the second optical compensation element 220). The first optical compensation element 210, the second optical compensation element 220 and the third optical compensation element 230 are adhered to the TFT array substrate 10 in the order of the first optical compensation element 210, the third optical compensation element 230 and the second optical compensation element 220. Note that the first optical compensation element 210, the second optical compensation element 220 and the third optical compensation element 230 may be adhered to the TFT array substrate 10 in another order (for example, in the order of the first optical compensation element 210, the second optical compensation element 220 and the third optical compensation element 230). In addition, the first optical compensation element 210, the second optical compensation element 220 and the third optical compensation element 230 may be integrated with a support body that is provided separately from the TFT array substrate 10.

As shown in FIG. 8, the third optical compensation element 230 is formed of a negative uniaxial retardation film (that is, C plate). The optical axis 231 of the third optical compensation element 230 is oriented along the direction (that is, Z direction) of the normal line of a plane (that is, XY-plane or the substrate plane of the TFT array substrate 10) of the third optical compensation element 230, which faces the first optical compensation element 210. Thus, an estimated index ellipsoid 232 is also oriented along the direction of the normal line (that is, Z direction).

Owing to the above configured third optical compensation element 230, it is possible to further reliably compensate for a light phase difference that occurs when light passes through the liquid crystal layer 50. In other words, by means of the first optical compensation element 210, the second optical compensation element 220 and the third optical compensation element 230, it is possible to further reduce the anisotropy of overall refractive index of a set of the liquid crystal layer 50, the first optical compensation element 210, the second optical compensation element 220 and the third optical compensation element 230. That is, it is possible to further approximate the index ellipsoid, which indicates the anisotropy of overall refractive index of a set of the liquid crystal layer 50, the first optical compensation element 210, the second optical compensation element 220 and the third optical compensation element 230, to a sphere. Thus, it is possible to further reliably prevent a decrease in contrast and a reduction in viewing angle range.

Particularly in the present embodiment, the third optical compensation element 230 is, for example, formed of an inorganic material using a vapor deposition method, or the like. Thus, the third optical compensation element 230 substantially or completely does not exhibit degradation due to ultraviolet light, or the like. Thus, it is possible to improve the light fastness and/or durability of the third optical compensation element 230 and, hence, it is possible to reduce or prevent degradation of quality over time in a display image.

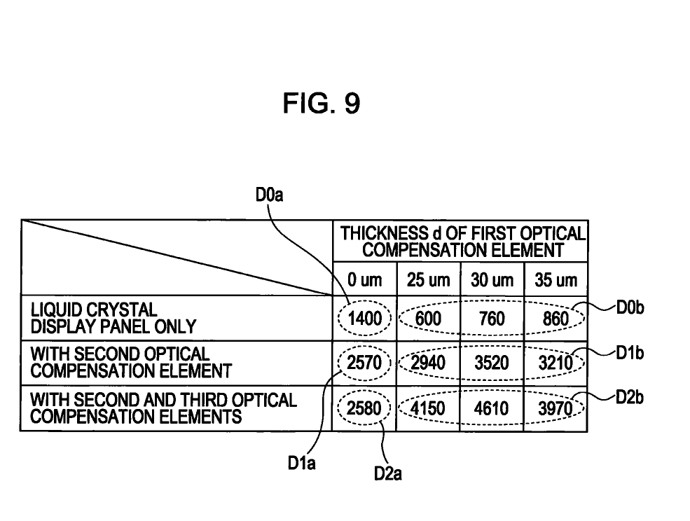

Next, an example of the measured result of the contrast (that is, contrast ratio) of a display image that is displayed by the liquid crystal device according to the above described first embodiment and the second embodiment will be described with reference to FIG. 9. Here, FIG. 9 is an example of the measured result of the contrast of a display image that is displayed by the liquid crystal device according to the first embodiment and the second embodiment. Note that, in FIG. 9, an example of the measured result of the contrast of a display image that is displayed by the liquid crystal device according to the first embodiment or the second embodiment is shown together with an example of the measured result of the contrast of a display image that is displayed by a liquid crystal device according to a comparative example. In addition, in this measurement, the first optical compensation element 210 is formed of rock crystal, which serves as a positive uniaxial crystal.

In FIG. 9, a piece of data D0a indicates the contrast of a display image that is displayed by the liquid crystal device formed of the liquid crystal display panel 100 singly (that is, the liquid crystal device in which none of the first optical compensation element 210, the second optical compensation element 220 and the third optical compensation element 230 is provided in the liquid crystal display panel 100). Pieces of data D0b indicate the contrast of a display image that is displayed by the liquid crystal device formed of the liquid crystal display panel 100 that includes the first optical compensation element 210 but does not include the second optical compensation element 220 or the third optical compensation element 230. Note that, in this measurement, the thickness d of the first optical compensation element 210 is varied to 25 um, 30 um and 35 um as a parameter. A piece of data D1a indicates the contrast of a display image that is displayed by the liquid crystal device formed of the liquid crystal display panel 100 that includes the second optical compensation element 220 but does not include the first optical compensation element 210 or the third optical compensation element 230. Pieces of data D1b indicate the contrast of a display image that is displayed by the liquid crystal device formed of the liquid crystal display panel 100 that includes the first optical compensation element 210 and the second optical compensation element 220 but does not include the third optical compensation element 230, that is, the liquid crystal device according to the above described first embodiment. A piece of data D2a indicates the contrast of a display image that is displayed by the liquid crystal device formed of the liquid crystal display panel 100 that includes the second optical compensation element 220 and the third optical compensation element 230 but does not include the first optical compensation element 210. Pieces of data D2b indicate the contrast of a display image that is displayed by the liquid crystal device formed of the liquid crystal display panel 100 that includes the first optical compensation element 210, the second optical compensation element 220 and the third optical compensation element 230, that is, the liquid crystal device according to the second embodiment.

As shown in FIG. 9, the contrast indicated by the data D0b when the liquid crystal display panel 100 only includes the first optical compensation element 210 is lower than the contrast indicated by the data D0a when the liquid crystal display panel 100 is used singly. However, the contrast indicated by the data D1b when the liquid crystal display panel 100 includes both the first optical compensation element 210 and the second optical compensation element 220, that is, in the case of the liquid crystal device according to the first embodiment, is higher than the contrast indicated by the data D0a when the liquid crystal display panel 100 is used singly. Furthermore, the contrast indicated by the data D1b in the case of the liquid crystal device according to the first embodiment is higher than the contrast indicated by the data D1a when the liquid crystal display panel 100 only includes the second optical compensation element 220. Thus, by providing the liquid crystal display panel 100 not with only the first optical compensation element 210 but with both the first optical compensation element 210 and the second optical compensation element 220, the contrast may be effectively enhanced. That is, as indicated by the data D1b, the liquid crystal device according to the first embodiment is able to display a high-contrast and high-quality image.

Moreover, as shown in FIG. 9, the contrast indicated by the data D2a when the liquid crystal display panel 100 includes the second optical compensation element 220 and the third optical compensation element 230 is substantially equal to the contrast indicated by the data D1a when the liquid crystal display panel 100 includes the second optical compensation element 220. That is, the contrast cannot substantially be enhanced by further providing the liquid crystal device, which is formed of the liquid crystal display panel 100 that includes the second optical compensation element 220, with the third optical compensation element 230. However, the contrast indicated by the data D2b when the liquid crystal display panel 100 includes the first optical compensation element 210, the second optical compensation element 220 and the third optical compensation element 230, that is, in the case of the liquid crystal device according to the second embodiment, is higher than the contrast indicated by the data D1a when the liquid crystal display panel 100 includes only the second optical compensation element 220. Thus, by providing the liquid crystal display panel 100 not with the second optical compensation element 220 and the third optical compensation element 230 only but with the three optical compensation elements that are the first optical compensation element 210, the second optical compensation element 220 and the third optical compensation element 230, the contrast may be further effectively enhanced. That is, as indicated by the data D2b, the liquid crystal device according to the second embodiment is able to display a high-contrast and high-quality image.

### Third Embodiment

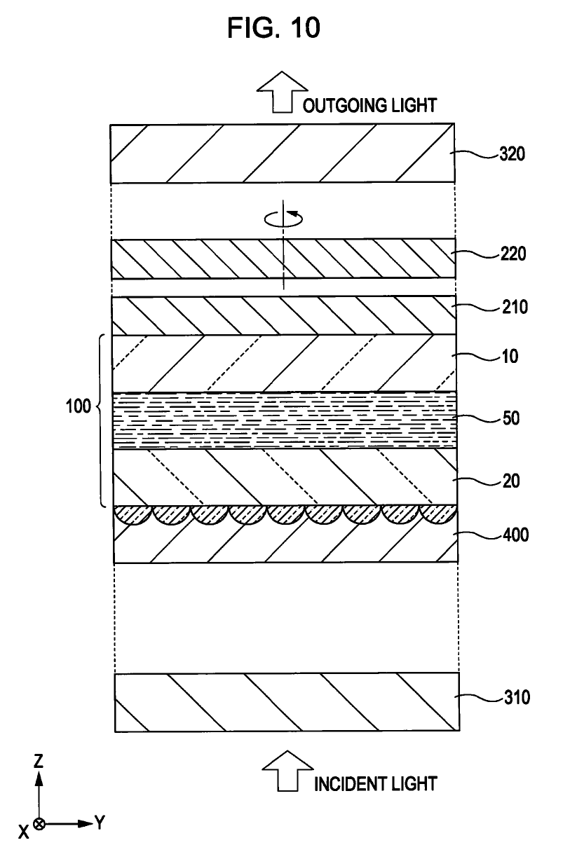

A liquid crystal device according to a third embodiment will be described with reference to FIG. 10 to FIG. 13.

First, positions at which the first and second optical compensation elements and the polarizers are arranged in the liquid crystal device according to the present embodiment will be described with reference to FIG. 10. Here, FIG. 10 is a cross-sectional view of the liquid crystal device according to the present embodiment, showing the configuration of the liquid crystal device and the incident direction in which incident light enters the liquid crystal device according to the present embodiment. Note that, in the following drawings, among the components shown in FIG. 1 and FIG. 2, the detailed components of the liquid crystal display panel 100 will be omitted appropriately and only the components that are directly relevant will be shown. In addition, for the sake of convenience, FIG. 10 is a view that is obtained by turning the TFT array substrate 10 and the opposite substrate 20, shown in FIG. 2, upside down.

As shown in FIG. 10, the liquid crystal device according to the present embodiment includes the liquid crystal display panel 100, the microlens array 400, the first optical compensation element 210, the second optical compensation element 220 and polarizers 310 and 320. The liquid crystal display panel 100, the microlens array 400, the first optical compensation element 210 and the second optical compensation element 220 are arranged so as to be held between the polarizers 310 and 320.

The microlens array 400 is a microlens array plate in which microlenses corresponding to pixels of the liquid crystal display panel 100 are formed. The microlens array 400 is provided between the incident side polarizer 310 and the liquid crystal display panel 100.

The first optical compensation element 210 and the second optical compensation element 220 are provided between the outgoing side polarizer 320 and the liquid crystal display panel 100. The first optical compensation element 210 is adhered to the TFT array substrate 10. The second optical compensation element 220 is supported by a support body, which is provided separately from the TFT array substrate 10, between the first optical compensation element 210 and the outgoing side polarizer 320. The second optical compensation element 220 is configured to be rotatable about an axis along the normal line of the substrate plane of the TFT array substrate 10.

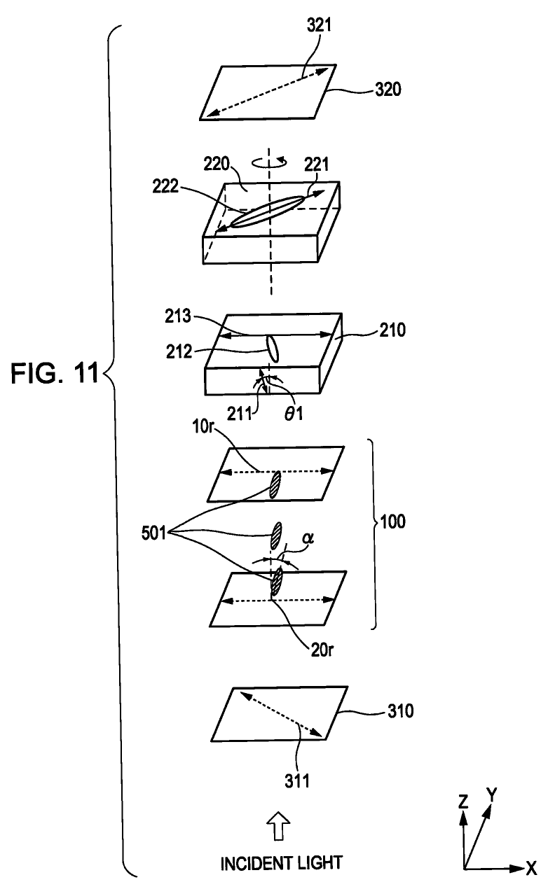

Next, the configuration of the first and second optical compensation elements and the polarizers will be described with reference to FIG. 11. Here, FIG. 11 is a perspective view of the first optical compensation element, the second optical compensation element and the polarizers according to the present embodiment. Note that, in FIG. 11, in addition to the first and second optical compensation elements and the polarizers, the status of liquid crystal molecules in the liquid crystal display panel 100, when no voltage is applied, is conceptionally shown. In addition, in FIG. 11, for the sake of convenience, an angle α and an angle θ1 are shown so as to be larger than the actual angles.

In FIG. 11, the liquid crystal molecules 501 in the liquid crystal layer 50, when no voltage is applied, are pretilted by the alignment layers 22 and 16 (see FIG. 2) within the plane of the opposite substrate 20 (or the TFT array substrate 10) at a predetermined angle from the plane in a predetermined direction (in a direction along the tilt direction 20r of the liquid crystal located adjacent to the boundary of the alignment layer 22 (that is, the tilt direction 10r of the liquid crystal located adjacent to the boundary of the alignment layer 16), which extends in a direction along an X direction in FIG. 11), and are aligned obliquely by a pretilt angle α with respect to the normal line of the opposite substrate 20 (or the TFT array substrate 10).

Each of the polarizers 310 and 320 is, for example, a polarizer that includes a polarizing film, formed of a PVA, or the like, that regulates polarization of light and a protective layer, formed of a TAC, or the like, that is arranged on each side of the polarizing film. The polarizer 310 is provided on a side of the liquid crystal display panel 100, from which light enters, so as to face the opposite substrate 20. The polarizer 320 is provided on a side of the liquid crystal display panel 100, from which light exits, so as to face to the TFT array substrate 10. The polarizers 310 and 320 are arranged in crossed-Nichols such that the polarization axis 311 of the polarizer 310 intersects perpendicularly with the polarization axis 321 of the polarizer 320. Each of the polarization axes 311 and 321 is oriented along a direction that is deviated at an angle of approximately 45 degrees from the tilt direction 20r of the liquid crystal located adjacent to the boundary of the alignment layer 22. Because alignment of the liquid crystal molecules 501 of the liquid crystal layer 50 is controlled in the VA mode as described above, the liquid crystal device according to the present embodiment displays an image in a normally black mode in which black is displayed on the image display area 10a (see FIG. 1) when no voltage is applied to the liquid crystal layer 50.

The first optical compensation element 210 is, for example, formed of a crystal plate that is formed from a positive uniaxial crystal, such as rock crystal. The optical axis 211 of the first optical compensation element 210 is inclined in a direction that is different from a direction, in which the major axes of the liquid crystal molecules 501 incline, with respect to the plane of the first optical compensation element 210, which faces the liquid crystal display panel 100 (that is, XY-plane). That is, for example, when viewed within one plane that is perpendicular to the TFT array substrate 10 along the tilt direction 10r, the optical axis 211 is inclined with respect to the normal line of the TFT array substrate 10 (that is, Z-axis) at an angle θ1 in a direction that is different from a direction in which the major axes of the liquid crystal molecules 501 incline. Thus, the estimated index ellipsoid 212 is also inclined at an angle θ1 with respect to the normal line of the TFT array substrate 10 in a direction that is different from a direction in which the major axes of the liquid crystal molecules 501 incline. The phase retardation axis 213 of the first optical compensation element 210 is oriented along the tilt direction 10r of the liquid crystal located adjacent to the boundary of the alignment layer 16.

Note that the first optical compensation element 210, as described with reference to FIG. 5, may be formed in such a manner that a positive uniaxial crystal is cut along the two cutting plane lines that are inclined at a predetermined angle with respect to the optical axis and is then polished so as to have a predetermined thickness.

Referring back to FIG. 11, the second optical compensation element 220 is formed of a positive uniaxial retardation film (that is, A plate). The second optical compensation element 220 is arranged so as to face the first optical compensation element 210 so that the optical axis 221 of the second optical compensation element 220 is oriented along the substrate plane of the TFT array substrate 10 (that is, XY-plane). Furthermore, the second optical compensation element 220 is configured to be rotatable about an axis along the direction of the normal line of the TFT array substrate 10 (that is, Z direction). Moreover, as will be described later, particularly in the present embodiment, the second optical compensation element 220 is adjusted by rotation so as to cancel a light phase difference that occurs because of the liquid crystal layer 50 and the first optical compensation element 210. In addition, the second optical compensation element 220 also has the function of minutely adjust the state of polarization of light.

Next, the operation of the above configured liquid crystal device according to the present embodiment will be described with reference to FIG. 6 together with FIG. 10 and FIG. 11.

In FIG. 10, when the liquid crystal device according to the present embodiment is operating, incident light initially enters the incident side polarizer 310. Note that the polarizer 310 only transmits light that oscillates in a direction along the polarization axis 311. That is, incident light becomes linearly polarized light after passing through the polarizer 310. The incident light that has passed through the polarizer 310 passes through the microlens array 400 and the opposite substrate 20 and then enters the liquid crystal layer 50.

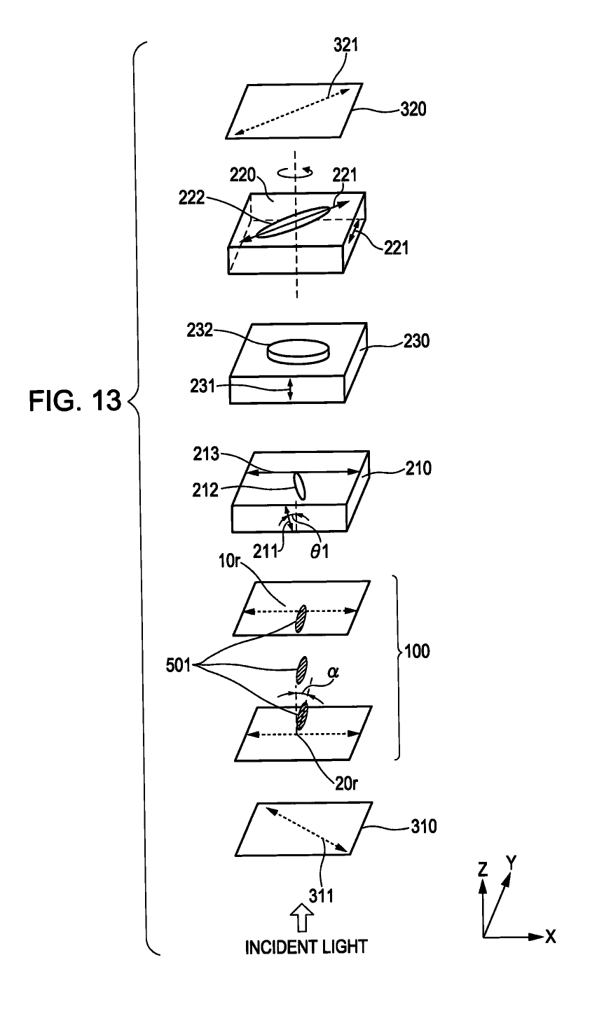

As shown in FIG. 11, the liquid crystal molecules 501 in the liquid crystal layer 50, when no voltage is applied, are aligned obliquely at the pretilt angle α in a direction along the tilt direction 10r (that is, a positive X-axis direction) with respect to the direction of the normal line of the TFT array substrate 10 (that is, Z direction). Thus, as shown in FIG. 13, the estimated index ellipsoid 501e that indicates the anisotropy of refractive index of the overall liquid crystal layer 50 is also inclined at the pretilt angle α in a direction along the tilt direction 10r (that is, the positive X-axis direction) with respect to the direction of the normal line of the TFT array substrate 10 (that is, Z direction). Therefore, if no measure is taken, light that has entered the liquid crystal layer 50 has a phase difference that occurs from a state in which the estimated index ellipsoid 501e of the liquid crystal layer 50 is inclined at the pretilt angle α, so that the light that has passed through the liquid crystal layer 50 enters the outgoing side polarizer 320 in a state where the phase of the light is shifted. In addition, there is a possibility that a phase difference may occur when incident light passes through the microlens array 400 or the polarizers 310 and 320. Thus, in the outgoing side polarizer 300b, there is a possibility that light, which is normally not allowed be passed, will leak.

Then, as shown in FIG. 11 and FIG. 6, because the liquid crystal device according to the present embodiment includes the first optical compensation element 210 and the second optical compensation element 220, it is possible to compensate for a light phase difference that occurs when incident light passes through the liquid crystal layer 50. In other words, by means of the first optical compensation element 210 and the second optical compensation element 220, it is possible to reduce the anisotropy of overall refractive index of a set of the liquid crystal layer 50, the first optical compensation element 210 and the second optical compensation element 220. In short, the first optical compensation element 210, which has the estimated index ellipsoid 212 inclined at the angle θ1 to a side opposite to that of the estimated index ellipsoid 501e, is arranged for the liquid crystal layer 50 that has the estimated index ellipsoid 501e inclined at the pretilt angle α, so that the estimated overall index ellipsoid 292 of a set of the liquid crystal layer 50 and the first optical compensation element 210 is approximated to a biaxial index ellipsoid. Thus, it is possible for the first optical compensation element 210 to compensate for a phase difference that occurs from a state in which the estimated index ellipsoid 501e of the liquid crystal layer 50 is inclined at the pretilt angle α. Furthermore, because the second optical compensation element 220 is adjusted by rotation so as to cancel a light phase difference that occurs because of the liquid crystal layer 50 and the first optical compensation element 210, it is possible to reduce the anisotropy of overall refractive index of a set of the liquid crystal layer 50, the first optical compensation element 210 and the second optical compensation element 220. In other words, the second optical compensation element 220 is, for example, adjusted by rotation so that, when no voltage is applied, light substantially or completely does not exit from the outgoing side polarizer 320, so that it is possible to reliably compensate for a light phase difference that occurs because of the liquid crystal layer 50 and the first optical compensation element 210.

By performing the above compensation, it is possible to prevent light, which has passed through the liquid crystal layer 50, from entering the outgoing side polarizer 320 in a state where the phase is shifted. Furthermore, because the second optical compensation element 220 has the function of adjusting the state of polarization of light, it is possible to allow light to enter the outgoing side polarizer 320 in a further appropriate state of polarization. Thus, for example, in the outgoing side polarizer 320, there is less possibility that light, which is normally not allowed to be passed, will leak, and thereby it is possible to prevent a decrease in contrast and a reduction in viewing angle range.

Furthermore, although the first optical compensation element 210 and the second optical compensation element 220 are never arranged obliquely with respect to the TFT array substrate 10 or the opposite substrate 20, it is possible to compensate for a light phase difference that occurs in the liquid crystal layer 50. Thus, it is suitable for miniaturization of the liquid crystal device, and the like.

Note that it is desirable that the retardation (Δn·d) of the first optical compensation element 210 with respect to the Z direction is substantially or completely equal to the retardation of the liquid crystal layer 50 with respect to the Z direction. In this case, it is possible to further enhance the advantageous effect in compensating for a phase difference that occurs in the liquid crystal layer 50. However, if the retardation of the first optical compensation element 210 in the Z direction is not substantially or completely equal to the retardation of the liquid crystal layer 50 in the Z direction, it is possible to appropriately enhance the advantageous effect in compensating for a phase difference that occurs in the liquid crystal layer 50 in accordance with a difference between the retardation of the first optical compensation element 210 in the Z direction and the retardation of the liquid crystal layer 50 in the Z direction. That is, for example, when the retardation of the liquid crystal layer 50 in the Z direction is 450 nm, the retardation of the first optical compensation element 210 is desirably 450 nm; however, when the retardation of the first optical compensation element 210 is, for example, within a range of 300 nm to 500 nm, it is possible to reliably enhance the advantageous effect in compensating for a phase difference that occurs in the liquid crystal layer 50. In addition, the retardation of the second optical compensation element 220 in the Z direction is desirably within a range of, for example, 10 nm to 100 nm. In this case, by the second optical compensation element 220 that is adjusted by rotation, it is possible to reliably obtain the advantageous effect in compensating for a light phase difference that occurs because of the liquid crystal layer 50 and the first optical compensation element 210.

In addition, particularly in the present embodiment, the first optical compensation element 210 and the second optical compensation element 220 are provided on the side of the liquid crystal display panel 100, from which light exits. That is, the first optical compensation element 210 and the second optical compensation element 220 are arranged on the side of the microlens array 400, from which light exits. Thus, it is possible for the first optical compensation element 210 and the second optical compensation element 220 to reliably compensate for a phase difference that occurs when light that is refracted by the microlens array 400 passes through the liquid crystal layer 50. In other words, it is possible to substantially or completely eliminate an adverse effect based on a light phase difference caused by the microlens array 400. Note that the first optical compensation element 210 and the second optical compensation element 220 may be provided on the side of the liquid crystal display panel 100, from which light enters (in other words, the side of the liquid crystal layer 50, from which light enters). In this case as well, it is possible to obtain the advantageous effect in compensating for a light phase difference.

As described above, the liquid crystal device according to the present embodiment is able to compensate for a phase difference that occurs in the liquid crystal layer 50 by means of the first optical compensation element 210 and the second optical compensation element 220. Thus, the liquid crystal device is able to display a relatively high-contrast and high-quality image and is also suitable for miniaturization.

### Fourth Embodiment

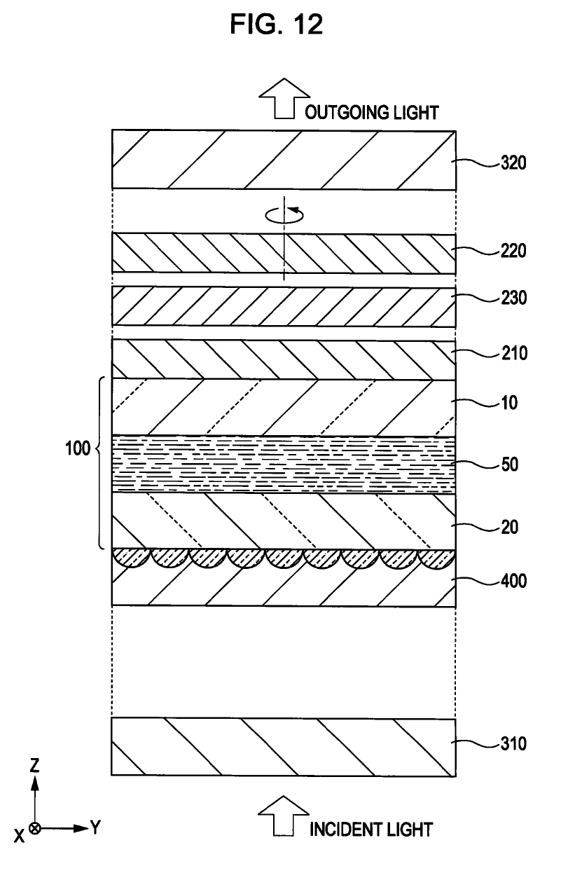

A liquid crystal device according to a fourth embodiment will be described with reference to FIG. 12 and FIG. 13. FIG. 12 is a cross-sectional view of the liquid crystal device, similar to FIG. 10 of the third embodiment. FIG. 13 is a perspective view of the first optical compensation element, the second optical compensation element and the polarizers, similar to FIG. 11 of the third embodiment. Note that, in FIG. 12 and FIG. 13, the same reference numerals are assigned to the same components as those of the third embodiment shown in FIG. 10 and FIG. 11, and the description thereof is omitted where appropriate.

In FIG. 12, the liquid crystal device according to the fourth embodiment differs from the liquid crystal device according to the above described third embodiment in that the third optical compensation element 230 is further provided, and the portions other than the above have substantially the same configuration as those of the liquid crystal device according to the above described third embodiment.

As shown in FIG. 12, the liquid crystal device according to the fourth embodiment includes the liquid crystal display panel 100, the microlens array 400, the first optical compensation element 210, the second optical compensation element 220, the third optical compensation element 230 and the polarizers 310 and 320.

The third optical compensation element 230 is provided between the outgoing side polarizer 320 and the liquid crystal display panel 100. The first optical compensation element 210, the second optical compensation element 220 and the third optical compensation element 230 are arranged, from the side adjacent to the liquid crystal display panel 100, in the order of the first optical compensation element 210, the third optical compensation element 230 and the second optical compensation element 220.

As shown in FIG. 13, the third optical compensation element 230 is formed of a negative uniaxial retardation film (that is, C plate). The optical axis 231 of the third optical compensation element 230 is oriented along the direction (that is, Z direction) of the normal line of a plane (that is, XY-plane or the substrate plane of the TFT array substrate 10) of the third optical compensation element 230, which faces the first optical compensation element 210. Thus, an estimated index ellipsoid 232 is also oriented along the direction of the normal line (that is, Z direction).

Owing to the above configured third optical compensation element 230, it is possible to further reliably compensate for a light phase difference that occurs when light passes through the liquid crystal layer 50. In other words, by means of the first optical compensation element 210, the second optical compensation element 220 and the third optical compensation element 230, it is possible to further reduce the anisotropy of overall refractive index of a set of the liquid crystal layer 50, the first optical compensation element 210, the second optical compensation element 220 and the third optical compensation element 230. That is, it is possible to further approximate the index ellipsoid, which indicates the anisotropy of overall refractive index of a set of the liquid crystal layer 50, the first optical compensation element 210, the second optical compensation element 220 and the third optical compensation element 230, to a sphere. Thus, it is possible to further reliably prevent a decrease in contrast and a reduction in viewing angle range.

Particularly in the present embodiment, the third optical compensation element 230 is, for example, formed of an inorganic material using a vapor deposition method, or the like. Thus, the third optical compensation element 230 substantially or completely does not exhibit degradation due to ultraviolet light, or the like. Thus, it is possible to improve the light fastness and/or durability of the third optical compensation element 230 and, hence, it is possible to reduce or prevent degradation of quality over time in a display image.

### Fifth Embodiment

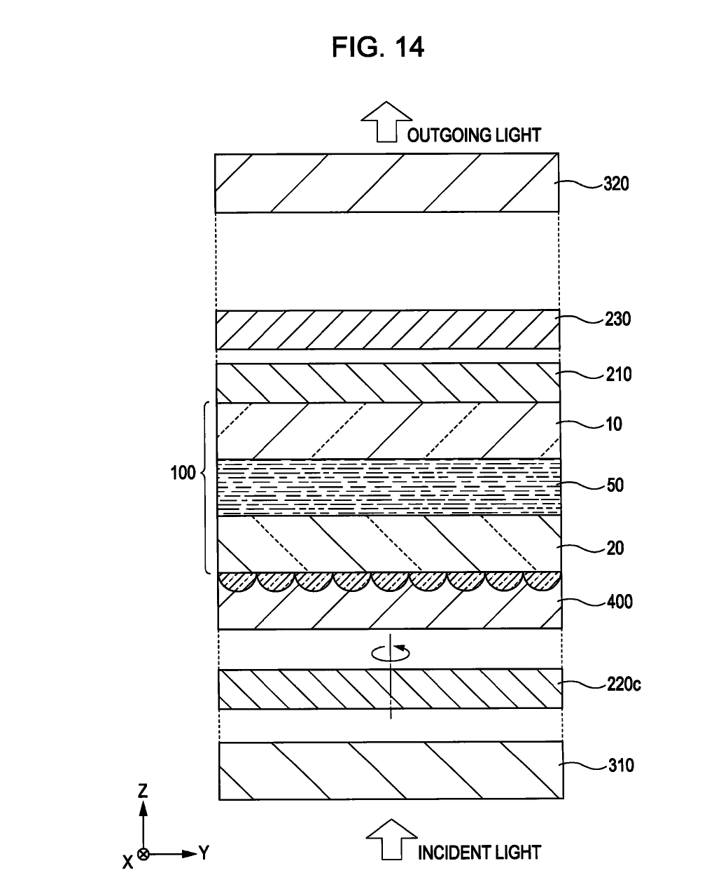

A liquid crystal device according to a fifth embodiment will be described with reference to FIG. 14. Here, FIG. 14 is a cross-sectional view of the liquid crystal device, similar to FIG. 10 of the third embodiment. Note that, in FIG. 14, the same reference numerals are assigned to the same components as those of the third embodiment shown in FIG. 10 and FIG. 11 or as those of the fourth embodiment shown in FIG. 12 and FIG. 13, and the description thereof are omitted where appropriate.

In FIG. 14, the liquid crystal device according to the fifth embodiment differs from the liquid crystal device according to the fourth embodiment in that a second optical compensation element 220c is provided in place of the second optical compensation element 220 of the above described fourth embodiment, and the portions other than the above have substantially the same configuration as those of the liquid crystal device according to the above described fourth embodiment.

As shown in FIG. 14, the liquid crystal device according to the fifth embodiment includes the liquid crystal display panel 100, the microlens array 400, the first optical compensation element 210, the second optical compensation element 220c, the third optical compensation element 230 and the polarizers 310 and 320.

Particularly, the present embodiment differs from the second optical compensation element 220 of the above described fourth embodiment in that the second optical compensation element 220c is provided between the incident side polarizer 310 and the liquid crystal display panel 100 (more specifically, between the polarizer 310 and the microlens array 400), and the portion other than the above have substantially the same configuration as that of the second optical compensation element according to the above described fourth embodiment.

Thus, when the liquid crystal device is, for example, provided in a projector as a light bulb, the second optical compensation element 220c may be easily adjusted by rotation so that it does not substantially or completely contact other members.

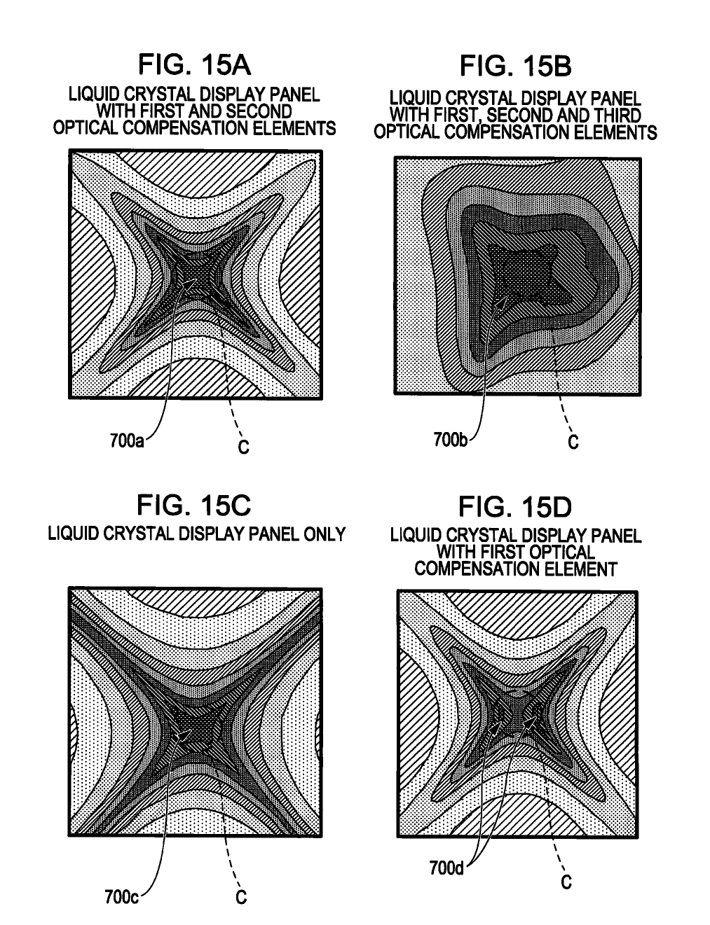

Next, the viewing angle range of the liquid crystal device according to the above described third and fourth embodiments will be described with reference to FIG. 15A to FIG. 15D. Here, FIG. 15A to FIG. 15D are examples of a viewing angle range characteristic chart, which are obtained through simulation. FIG. 15A is a viewing angle range characteristic chart of the liquid crystal device according to the third embodiment. FIG. 15B is a viewing angle range characteristic chart of the liquid crystal device according to the fourth embodiment. FIG. 15C is a viewing angle range characteristic chart of a liquid crystal device according to a first comparative example. FIG. 15D is a viewing angle range characteristic chart of a liquid crystal device according to a second comparative example.

In the above simulation, the liquid crystal display panel 100 includes a liquid crystal layer, of which the pretilt angle α is 5 degrees and the retardation (Δn·d) in the Z direction is 420 nm, as the liquid crystal layer 50. Furthermore, in the above simulation, the angle θ1, at which the optical axis 211 of the first optical compensation element 210 is inclined, is 5 degrees (that is, the angle equal to the pretilt angle α). The retardation of the first optical compensation element 210 in the Z direction is 300 nm. Moreover, in the above simulation, the front phase difference of the second optical compensation element 220 is 20 nm, and the retardation of the third optical compensation element 230 in the Z direction is −300 nm.

In FIG. 15A to FIG. 15D, the contrast is calculated for each polar angle (that is, an angle at which the normal line of the display screen of the liquid crystal display panel makes with the direction of measurement or observation) in each azimuth, and the contrast is mapped for each polar angle in each azimuth. In addition, regions of the same kind exhibit a contrast within the same range. A thicker color exhibits a higher contrast. In addition, positions that are located along a direction from the center of the viewing angle range characteristic chart to an outer periphery represent the values of polar angle in the same azimuth. As shown in FIG. 15A to FIG. 15D, the contrast depends on an azimuth and a polar angle.

A region (that is, a thick color region) 700a that exhibits a high contrast in the liquid crystal device according to the third embodiment shown in FIG. 15A (that is, the liquid crystal device formed of the liquid crystal display panel 100 that includes the first optical compensation element 210 and the second optical compensation element 220) is not wider than a region 700c (that is, a region that exhibits a contrast of the same range as the contrast exhibited by the region 700a in the liquid crystal device according to the third embodiment shown in FIG. 15A) that exhibits a high contrast in the liquid crystal device according to the first comparative example shown in FIG. 15C (that is, the liquid crystal device formed of the liquid crystal display panel 100 singly). However, in comparison with the region 700c, the region 700a is wide, that is, the viewing angle range is wide, particularly when focusing on a range (in the drawing, a region inside a circle C indicated by the broken line) in which the polar angle is 0 degrees to 15 degrees, at which a relatively high contrast is required when the liquid crystal device is used as a liquid crystal light bulb of a projector. Thus, as shown in FIG. 15A, the liquid crystal device according to the third embodiment is able to enhance the contrast when projection display is performed as compared with, for example, the liquid crystal device according to the first comparative example shown in FIG. 15C.

Furthermore, a region 700d (that is, a region that exhibits a contrast of the same range as the contrast exhibited by the region 700a in the liquid crystal device according to the third embodiment shown in FIG. 15A) that exhibits a high contrast in the liquid crystal device according to a second comparative example shown in FIG. 15D (that is, the liquid crystal device formed of the liquid crystal display panel 100 that only includes the first optical compensation element 210) is narrower than the region 700c that exhibits a high contrast in the liquid crystal device according to the first comparative example shown in FIG. 15C (that is, the liquid crystal device formed of the liquid crystal display panel 100 singly). Thus, by providing the liquid crystal display panel 100 not with only the first optical compensation element 210 but with both the first optical compensation element 210 and the second optical compensation element, the contrast may be effectively enhanced.

A region 700b (that is, a region that exhibits a contrast of the same range as the contrast exhibited by the region 700a in the liquid crystal device according to the first embodiment shown in FIG. 15A) that exhibits a high contrast in the liquid crystal device according to the fourth embodiment shown in FIG. 15B (that is, the liquid crystal device formed of the liquid crystal display panel 100 that includes the first optical compensation element 210, the second optical compensation element 220 and the third optical compensation element 230) is wider than the region 700c that exhibits a high contrast in the liquid crystal device according to the first comparative example shown in FIG. 15C. Thus, as shown in FIG. 15B, the liquid crystal device according to the fourth embodiment is able to increase the viewing angle range as compared with, for example, the liquid crystal device according to the first comparative example shown in FIG. 15C.

Furthermore, the region 700b that exhibits a high contrast in the liquid crystal device according to the fourth embodiment shown in FIG. 15B is wider than the region 700a that exhibits a high contrast in the liquid crystal device according to the third embodiment shown in FIG. 15A. Thus, as shown in FIG. 15B, the liquid crystal device according to the fourth embodiment is able to further increase the viewing angle range.

### Sixth Embodiment

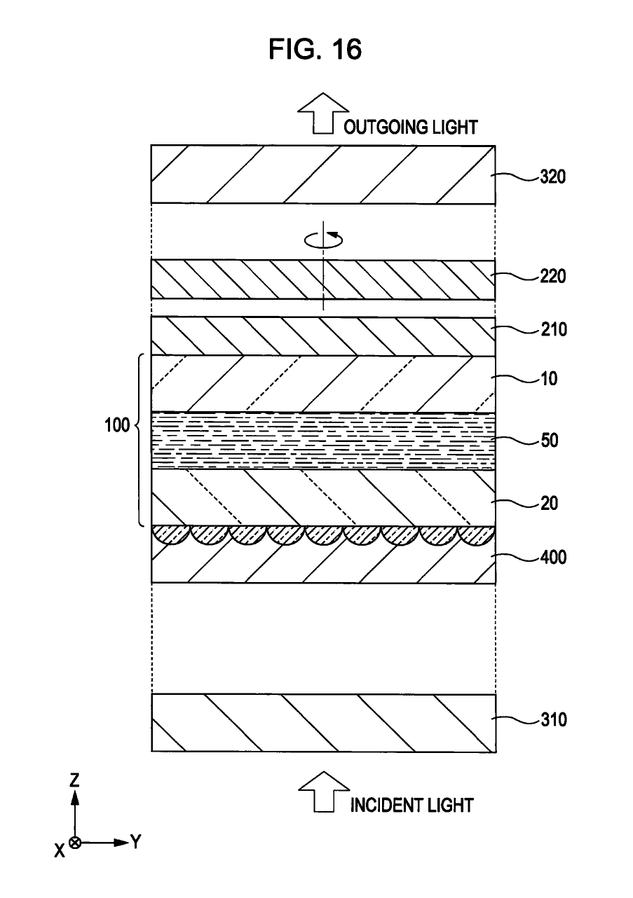

A liquid crystal device according to a sixth embodiment will be described with reference to FIG. 16 to FIG. 19.

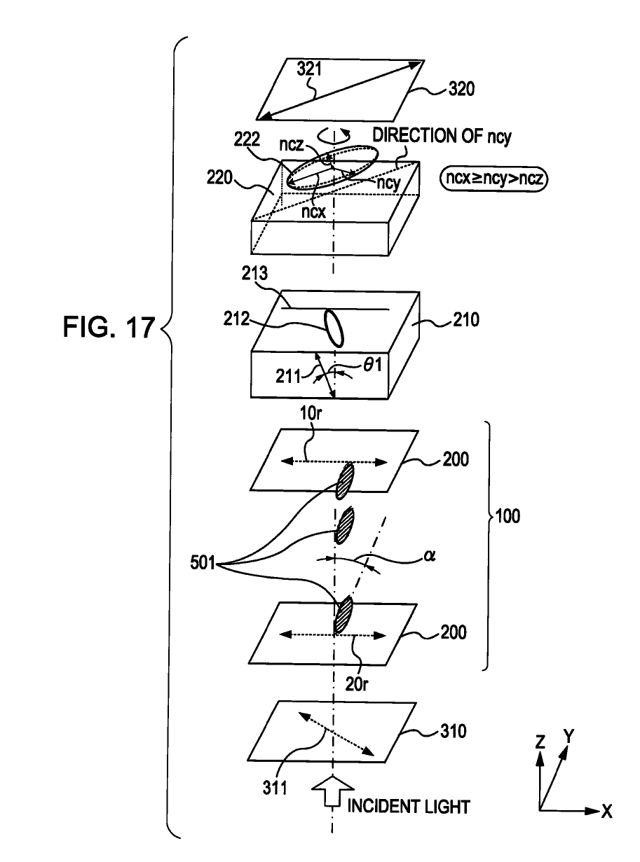

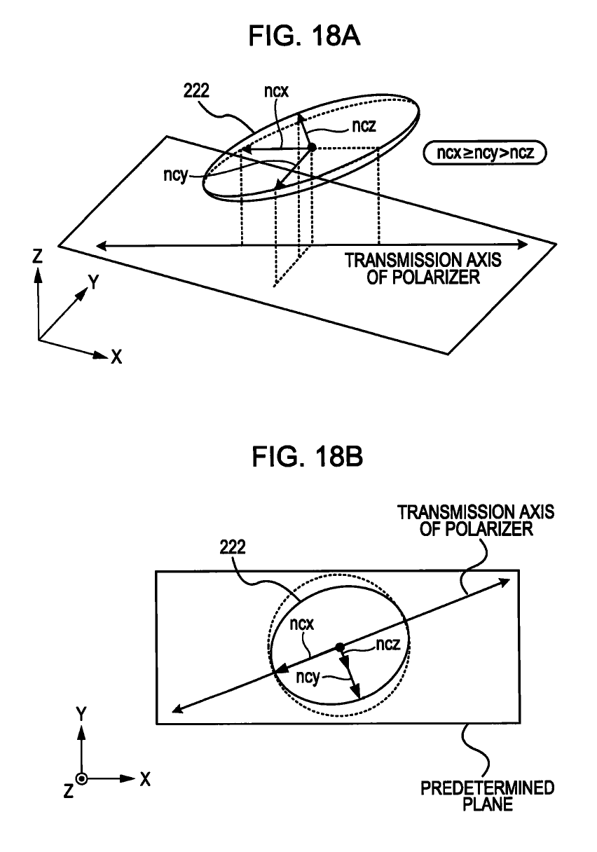

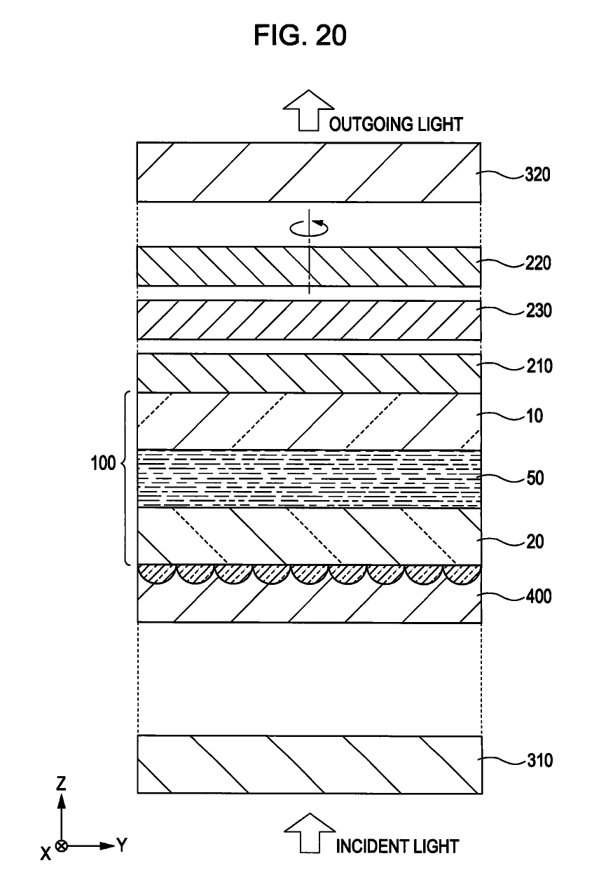

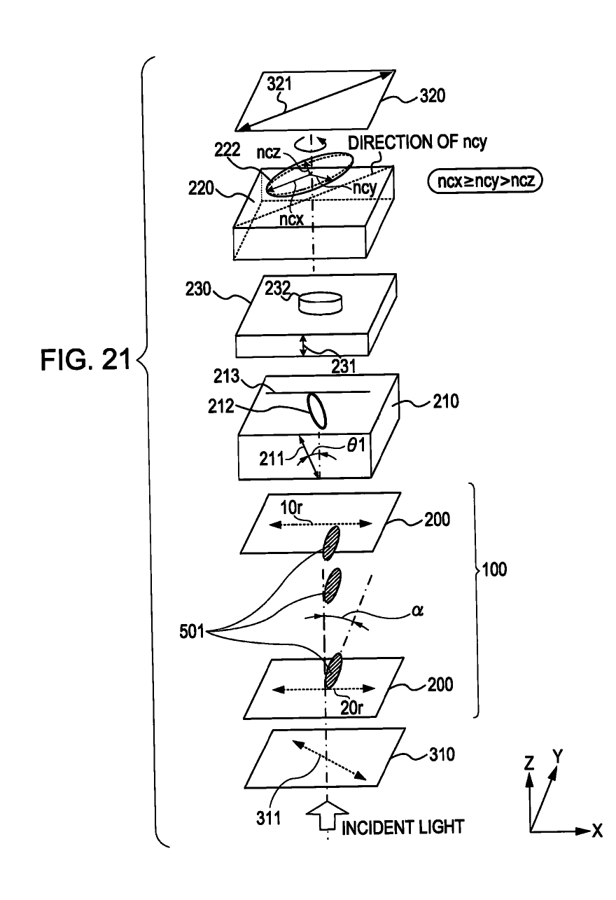

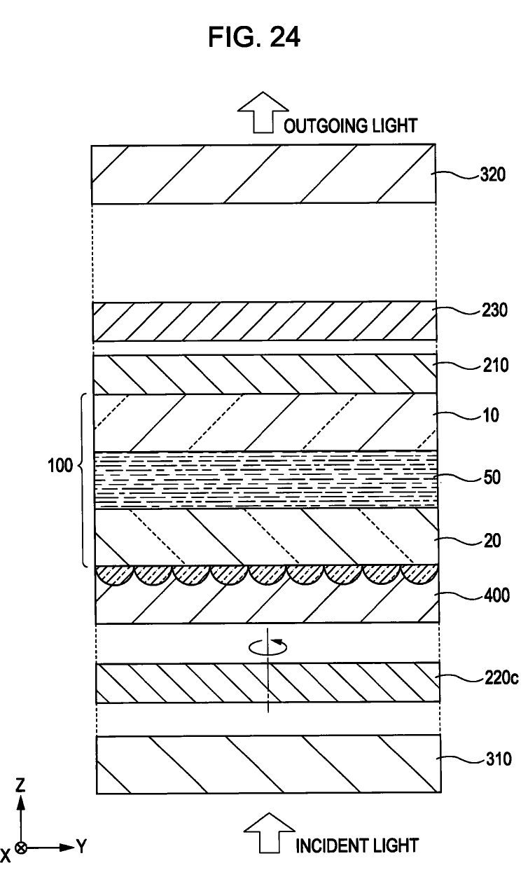

First, positions at which the first and second optical compensation elements and polarizers are arranged in the liquid crystal device according to the present embodiment will be described with reference to FIG. 16. Here, FIG. 16 is a cross-sectional view of the liquid crystal device according to the present embodiment, showing the configuration of the liquid crystal device and the incident direction in which incident light enters the liquid crystal device according to the present embodiment. Note that, in the following drawings, among the components shown in FIG. 1 and FIG. 2, the detailed components of the liquid crystal display panel 100 will be omitted appropriately and only the components that are directly relevant will be shown. In addition, for the sake of convenience, FIG. 16 is a view that is obtained by turning the TFT array substrate 10 and the opposite substrate 20, shown in FIG. 2, upside down. In addition, the X direction, the Y direction and the Z direction in FIG. 17, FIG. 18, FIG. 20, FIG. 21 and FIG. 24, which will be described later, in addition to FIG. 16, are common throughout the embodiments. The Z direction represents a direction in which light advances. The X direction is perpendicular to the Z direction. The Y direction is perpendicular to the Z direction and the X direction. A planar direction defined by the X direction and the Y direction represents the planar direction of a polarizing glass or the liquid crystal display panel. In addition, when the X direction, the Y direction and the Z direction are indicated, a direction denoted by a circle in which X is arranged indicates a direction toward the far side of the sheet, a direction denoted by a circle in which a black circle is arranged indicates a direction toward the near side of the sheet.

As shown in FIG. 16, the liquid crystal device according to the present embodiment includes the liquid crystal display panel 100, the microlens array 400, the first optical compensation element 210, the second optical compensation element 220 and the polarizers 310 and 320. The liquid crystal display panel 100, the microlens array 400, the first optical compensation element 210 and the second optical compensation element 220 are arranged so as to be held between the polarizers 310 and 320.

The microlens array 400 is a microlens array plate in which microlenses corresponding to pixels of the liquid crystal display panel 100 are formed. The microlens array 400 is provided between the incident side polarizer 310 and the liquid crystal display panel 100. Owing to the microlens array 400, incident light may be collected in units of pixels, and an actual aperture ratio of the liquid crystal display panel 100 may be improved.

The first optical compensation element 210 and the second optical compensation element 220 are provided between the outgoing side polarizer 320 and the liquid crystal display panel 100. The first optical compensation element 210 is adhered to the TFT array substrate 10. The second optical compensation element 220 is supported by a support body, which is provided separately from the TFT array substrate 10, between the first optical compensation element 210 and the outgoing side polarizer 320. The second optical compensation element 220 is configured to be rotatable about an axis along the normal line of the substrate plane of the TFT array substrate 10.

Next, the configuration of the first and second optical compensation elements and the polarizers according to the sixth embodiment will be described with reference to FIG. 17. Here, FIG. 17 is a perspective view of the first optical compensation element, the second optical compensation element and the polarizers according to the present embodiment. Note that, in FIG. 17, in addition to the first and second optical compensation elements and the polarizers, the status of liquid crystal molecules in the liquid crystal display panel 100, when no voltage is applied, is conceptionally shown. In addition, in FIG. 17, for the sake of convenience, an angle α and an angle θ1 are shown so as to be larger than the actual angles.

As shown in FIG. 17, the liquid crystal molecules 501 in the liquid crystal layer 50, when no voltage is applied, are pretilted by the alignment layers 22 and 16 (see FIG. 2) within the plane of the opposite substrate 20 (or the TFT array substrate 10) at a predetermined angle from the plane in a predetermined direction (in a direction along the tilt direction 20r of the liquid crystal located adjacent to the boundary of the alignment layer 22 (that is, the tilt direction 10r of the liquid crystal located adjacent to the boundary of the alignment layer 16), which extends in a direction along the X direction in FIG. 17), and are aligned obliquely at the pretilt angle α with respect to the normal line of the opposite substrate 20 (or the TFT array substrate 10).

Each of the polarizers 310 and 320 is, for example, a polarizer that includes a polarizing film, formed of a PVA, or the like, that regulates polarization of light and a protective layer, formed of a TAC, or the like, that is arranged on each side of the polarizing film. The polarizer 310 is provided on a side of the liquid crystal display panel 100, from which light enters, so as to face the opposite substrate 20. The polarizer 320 is provided on a side of the liquid crystal display panel 100, from which light exits, so as to face to the TFT array substrate 10. The polarizers 310 and 320 are arranged in crossed-Nichols such that the polarization axis 311 of the polarizer 310 intersects perpendicularly with the polarization axis 321 of the polarizer 320. Each of the polarization axes 311 and 321 is oriented along a direction that is deviated at an angle of approximately 45 degrees from the tilt direction 20r of the liquid crystal located adjacent to the boundary of the alignment layer 22 (that is, the tilt direction 10r of the liquid crystal located adjacent to the boundary of the alignment layer 16). Because alignment of the liquid crystal molecules 501 of the liquid crystal layer 50 is controlled in the VA mode as described above, the liquid crystal device according to the present embodiment displays an image in a normally black mode in which black is displayed on the image display area 10a (see FIG. 1) when no voltage is applied to the liquid crystal layer 50.

The first optical compensation element 210 is, for example, formed of a crystal plate that is formed from a positive uniaxial crystal, such as rock crystal. The optical axis 211 of the first optical compensation element 210 is inclined in a direction that is different from a direction, in which the major axes of the liquid crystal molecules 501 incline, with respect to the plane of the first optical compensation element 210, which faces the liquid crystal display panel 100 (that is, XY-plane). That is, for example, when viewed within one plane that is perpendicular to the TFT array substrate 10 along the tilt direction 10r, the optical axis 211 is inclined with respect to the normal line of the TFT array substrate 10 (that is, Z-axis) at an angle θ1 in a direction that is different from a direction in which the major axes of the liquid crystal molecules 501 incline. Thus, the estimated index ellipsoid 212 is also inclined at an angle θ1 with respect to the normal line of the TFT array substrate 10 in a direction that is different from a direction in which the major axes of the liquid crystal molecules 501 incline. The phase retardation axis 213 of the first optical compensation element 210 is oriented along the tilt direction 10r of the liquid crystal located adjacent to the boundary of the alignment layer 16 (that is, the tilt direction 20r of the liquid crystal located adjacent to the boundary of the alignment layer 22 or the X direction). More specifically, the first optical axis 211 is oriented along a direction that is symmetrical with the major axes of the pretilted liquid crystal molecules 501 with respect to the plane of the first optical compensation element 210, which faces the liquid crystal display panel 100 (that is, XY-plane), and the angle θ1 is set so as to be substantially or practically completely equal to the pretilt angle α.

Note that the first optical compensation element 210, as described with reference to FIG. 5, may be formed in such a manner that a positive uniaxial crystal is cut along the two cutting plane lines that are inclined at a predetermined angle with respect to the optical axis and is then polished so as to have a predetermined thickness.

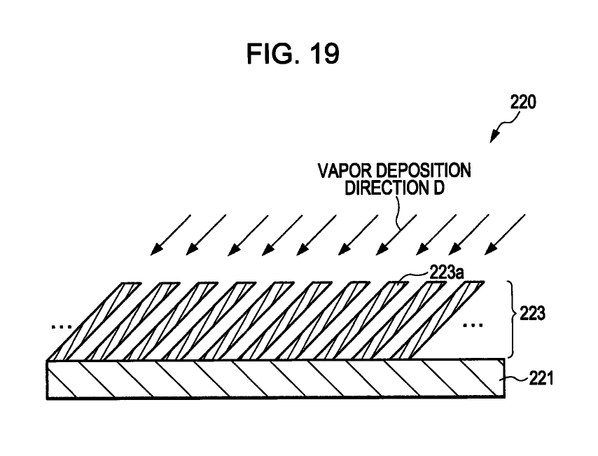

Next, the configuration of the second optical compensation element according to the present embodiment will be described with reference to the above described FIG. 17 together with FIG. 18A, FIG. 18B and FIG. 19. Here, FIG. 18A is an outside perspective view that schematically shows the positional relationship between a negative biaxial index ellipsoid and the substrate plane (that is, XY-plane) of the TFT array substrate according to the present embodiment. FIG. 18B is a plan view that schematically shows the positional relationship between the negative biaxial index ellipsoid and the substrate plane of the TFT array substrate. FIG. 19 is a cross-sectional view that shows the configuration of the second optical compensation element according to the present embodiment.

As shown in the above described FIG. 17, FIG. 18A and FIG. 18B, the second optical compensation element 220 has a negative biaxial index ellipsoid 222, and the axis that is oriented along the direction of a main axis ncz of the negative biaxial index ellipsoid 222 is inclined with respect to the substrate plane of the TFT array substrate 10 (that is, XY-plane). Note that the refractive index of the negative biaxial index ellipsoid 222 satisfies the following conditional expression (1).

(refractive index ncx)>(refractive index ncy)>(refractive index ncz) (1)

Note that, in this conditional expression (1), the refractive index ncx may be approximately equal to the refractive index ncy.

In addition, a phase retardation axis occurs in the second optical compensation element 220 because of the inclined main axis ncz of the negative biaxial index ellipsoid 222. Here, the phase retardation axis according to the present embodiment means a direction in which the refractive index is maximal when the optical anisotropy that is represented three-dimensionally using an index ellipsoid is cut along a predetermined plane. Furthermore, the phase retardation axis that occurs in the second optical compensation element 220 is configured to be rotatable about an axis along the direction of the normal line of the TFT array substrate 10 (that is, Z direction). Typically, the direction in which the phase retardation axis extends may be made parallel to the polarization axis of the polarizer. Furthermore, the second optical compensation element 220 is arranged so as to face the first optical compensation element 210.

Typically, the case in which the above described negative biaxial index ellipsoid 222 is inclined with respect to the substrate plane of the TFT array substrate 10 (that is, XY-plane) using the refractive index ncx as an axis, as shown in FIG. 18A, will be described. In this case, as shown in the plan view of FIG. 18B, when the negative biaxial index ellipsoid 222 is cut along a predetermined plane parallel to the XY-plane, because the direction of the refractive index ncx is included in the predetermined plane, the size of which the refractive index ncx is projected onto the predetermined plane does not change. In contrast, because the direction of the refractive index ncy in the negative biaxial index ellipsoid 222 is inclined with respect to the predetermined plane, the size of which the refractive index ncy is projected onto the predetermined plane may be further reduced below the absolute value |ncx| of the refractive index ncx. Note that the dotted circle in FIG. 18B indicates the size of the projected refractive index ncx and the size of the projected refractive index ncy when the negative biaxial index ellipsoid 222 is not inclined.

Typically, as shown in FIG. 19, the above described second optical compensation element 220 includes a predetermined substrate 221 and a vapor deposited film 223. The vapor deposited film 223 is obliquely vapor deposited on the predetermined substrate so that the vapor deposited film 223 has the above described index ellipsoid 222 and the optical axis of the index ellipsoid 222 is inclined with respect to the substrate plane of the TFT array substrate 10 (that is, XY-plane). Specifically, as shown in FIG. 19, the second optical compensation element 220 according to the present embodiment includes the predetermined substrate 221 that is formed of a transparent glass substrate, or the like, and an inorganic film 223 that is formed on the predetermined substrate 221. The inorganic film 223 is formed on the predetermined substrate 221 in such a manner that an inorganic material, such as Ta2O5, is vapor deposited on the predetermined substrate 221 in a vapor deposition direction D that is an oblique direction with respect to the predetermined substrate 221. Here, as shown in FIG. 19, the inorganic film 223 microscopically has a film structure that includes a portion at which a column structure in which an inorganic material is deposited along the vapor deposition direction D. The above structured inorganic film 223, to a greater or lesser degree, generates a phase difference depending on its fine structure. The inorganic film 223 of the second optical compensation element 220 microscopically has columnar portions 223a that extend from the predetermined substrate 221 along the vapor deposition direction D of the inorganic material when viewed in cross section. Typically, the inorganic film 223 of the second optical compensation element 220 is desirably configured to include an inorganic material. In this manner, it is possible to effectively prevent degradation of the second optical compensation element 220 due to irradiation of light and a following increase in temperature and, hence, it is possible to form a reliable liquid crystal device.

Moreover, as will be described later, particularly in the present embodiment, the second optical compensation element 220 is adjusted by rotation so as to cancel a light phase difference that occurs because of the liquid crystal layer 50 and the first optical compensation element 210. In addition, the second optical compensation element 220 also has the function of minutely adjust the state of polarization of light.

Next, the operation of the above configured liquid crystal device according to the present embodiment will be described with reference to FIG. 6 together with FIG. 16 and FIG. 17.

As shown in FIG. 16, when the liquid crystal device according to the present embodiment is operating, incident light initially enters the incident side polarizer 310. Note that the polarizer 310 only transmits light that oscillates in a direction along the polarization axis 311. That is, incident light becomes linearly polarized light after passing through the polarizer 310. The incident light that has passed through the polarizer 310 passes through the microlens array 400 and the opposite substrate 20 and then enters the liquid crystal layer 50.

As shown in FIG. 17, the liquid crystal molecules 501 in the liquid crystal layer 50, when no voltage is applied, are aligned obliquely at the pretilt angle α in a direction along the tilt direction 10r (that is, a positive X-axis direction) with respect to the direction of the normal line of the TFT array substrate 10 (that is, Z direction). Thus, as shown in FIG. 6, the index ellipsoid 501e that indicates the anisotropy of refractive index of the overall liquid crystal layer 50 is also inclined at the pretilt angle α in a direction along the tilt direction 10r (that is, the positive X-axis direction) with respect to the direction of the normal line of the TFT array substrate 10 (that is, Z direction). Therefore, if no measure is taken, light that has entered the liquid crystal layer 50 has a phase difference that occurs from a state in which the index ellipsoid 501e of the liquid crystal layer 50 is inclined at the pretilt angle α, so that the light that has passed through the liquid crystal layer 50 enters the outgoing side polarizer 320 in a state where the phase of the light is shifted. In addition, there is a possibility that a phase difference may occur when incident light passes through the microlens array 400 or the polarizer 310 or 320. Thus, in the outgoing side polarizer 300b, there is a possibility that light, which is normally not allowed be passed, will leak.

Then, as shown in the above described FIG. 17 and FIG. 6, because the liquid crystal device according to the present embodiment includes the first optical compensation element 210 and the second optical compensation element 220, it is possible to compensate for a light phase difference that occurs when incident light passes through the liquid crystal layer 50. In other words, by means of the first optical compensation element 210 and the second optical compensation element 220, it is possible to reduce the anisotropy of overall refractive index of a set of the liquid crystal layer 50, the first optical compensation element 210 and the second optical compensation element 220. In short, the first optical compensation element 210, which has the index ellipsoid 212 inclined at the angle θ1 to a side opposite to that of the index ellipsoid 501e, is arranged for the liquid crystal layer 50 that has the index ellipsoid 501e inclined at the pretilt angle α, so that the estimated overall index ellipsoid 292 of a set of the liquid crystal layer 50 and the first optical compensation element 210 is approximated to a biaxial index ellipsoid. Thus, it is possible for the first optical compensation element 210 to compensate for a phase difference that occurs from a state in which the index ellipsoid 501e of the liquid crystal layer 50 is inclined at the pretilt angle α. Furthermore, the above described second optical compensation element 220, that is, the second optical compensation element 220 that has the negative biaxial index ellipsoid 222 of which the main axis (or optical axis) is inclined with respect to the substrate plane of the TFT array substrate 10 (that is, XY-plane) is adjusted by rotation so as to cancel a light phase difference that occurs because of the liquid crystal layer 50 and the first optical compensation element 210. Thus, it is possible to reduce the anisotropy of overall refractive index of a set of the liquid crystal layer 50, the first optical compensation element 210 and the second optical compensation element 220. In other words, the second optical compensation element 220 is, for example, adjusted by rotation so that, when no voltage is applied, light substantially or completely does not exit from the outgoing side polarizer 320, so that it is possible to reliably compensate for a light phase difference that occurs because of the liquid crystal layer 50 and the first optical compensation element 210.

By performing the above compensation, it is possible to prevent light, which has passed through the liquid crystal layer 50, from entering the outgoing side polarizer 320 in a state where the phase is shifted. Furthermore, because the second optical compensation element 220 has the function of adjusting the state of polarization of light, it is possible to allow light to enter the outgoing side polarizer 320 in a further appropriate state of polarization. Thus, for example, in the outgoing side polarizer 320, there is less possibility that light, which is normally not allowed to be passed, will leak, and thereby it is possible to prevent a decrease in contrast and a reduction in viewing angle range.

Furthermore, although the first optical compensation element 210 and the second optical compensation element 220 are never arranged obliquely with respect to the TFT array substrate 10 or the opposite substrate 20, it is possible to compensate for a light phase difference that occurs in the liquid crystal layer 50. Thus, it is suitable for miniaturization of the liquid crystal device, and the like.

Note that it is desirable that the retardation (Δn·d) of the first optical compensation element 210 in the Z direction is substantially or completely equal to the retardation of the liquid crystal layer 50 in the Z direction. In this case, it is possible to further enhance the advantageous effect in compensating for a phase difference that occurs in the liquid crystal layer 50. However, if the retardation of the first optical compensation element 210 in the Z direction is not substantially or completely equal to the retardation of the liquid crystal layer 50 in the Z direction, it is possible to appropriately enhance the advantageous effect in compensating for a phase difference that occurs in the liquid crystal layer 50 in accordance with a difference between the retardation of the first optical compensation element 210 in the Z direction and the retardation of the liquid crystal layer 50 in the Z direction. That is, for example, when the retardation of the liquid crystal layer 50 in the Z direction is 450 nm, the retardation of the first optical compensation element 210 is desirably 450 nm; however, when the retardation of the first optical compensation element 210 is, for example, within a range of 300 nm to 500 nm, it is possible to reliably enhance the advantageous effect in compensating for a phase difference that occurs in the liquid crystal layer 50. In addition, the retardation of the second optical compensation element 220 in the Z direction is desirably within a range of, for example, 10 nm to 100 nm. In this case, by the second optical compensation element 220 that is adjusted by rotation, it is possible to reliably obtain the advantageous effect in compensating for a light phase difference that occurs because of the liquid crystal layer 50 and the first optical compensation element 210.

In addition, particularly in the present embodiment, the first optical compensation element 210 and the second optical compensation element 220 are provided on the side of the liquid crystal display panel 100, from which light exits. That is, the first optical compensation element 210 and the second optical compensation element 220 are arranged on the side of the microlens array 400, from which light exits. Thus, it is possible for the first optical compensation element 210 and the second optical compensation element 220 to reliably compensate for a phase difference that occurs when light that is refracted by the microlens array 400 passes through the liquid crystal layer 50. In other words, it is possible to substantially or completely eliminate an adverse effect based on a light phase difference caused by the microlens array 400. Note that the first optical compensation element 210 and the second optical compensation element 220 may be provided on the side of the liquid crystal display panel 100, from which light enters (in other words, the side of the liquid crystal layer 50, from which light enters). In this case as well, it is possible to obtain the advantageous effect in compensating for a light phase difference.

As described above, the liquid crystal device according to the present embodiment is able to compensate for a phase difference that occurs in the liquid crystal layer 50 by means of the first optical compensation element 210 and the second optical compensation element 220. Thus, the liquid crystal device is able to display a relatively high-contrast and high-quality image and is also suitable for miniaturization.

### Seventh Embodiment

A liquid crystal device according to a seventh embodiment will be described with reference to FIG. 20 and FIG. 21. Here, FIG. 20 is a cross-sectional view of the liquid crystal device, similar to FIG. 16 of the sixth embodiment. FIG. 21 is a perspective view of the first optical compensation element, the second optical compensation element and the polarizers, similar to FIG. 17 of the sixth embodiment. Note that, in FIG. 20 and FIG. 21, the same reference numerals are assigned to the same components as those of the sixth embodiment shown in FIG. 16 and FIG. 17, and the description thereof is omitted where appropriate.

As shown in FIG. 20, the liquid crystal device according to the seventh embodiment differs from the liquid crystal device according to the above described sixth embodiment in that the third optical compensation element 230 is further provided, and the portions other than the above have substantially the same configuration as those of the liquid crystal device according to the above described sixth embodiment.

As shown in FIG. 20, the liquid crystal device according to the seventh embodiment includes the liquid crystal display panel 100, the microlens array 400, the first optical compensation element 210, the second optical compensation element 220, the third optical compensation element 230 and the polarizers 310 and 320.

The third optical compensation element 230 is provided between the outgoing side polarizer 300b and the liquid crystal display panel 100 (more specifically, between the first optical compensation element 210 and the second optical compensation element 220). The first optical compensation element 210, the second optical compensation element 220 and the third optical compensation element 230 are arranged, from the side adjacent to the liquid crystal display panel 100, in the order of the first optical compensation element 210, the third optical compensation element 230 and the second optical compensation element 220. Note that the first optical compensation element 210, the second optical compensation element 220 and the third optical compensation element 230 may be adhered from the side adjacent to the liquid crystal display panel 100 in another order (for example, in the order of the first optical compensation element 210, the second optical compensation element 220 and the third optical compensation element 230). In addition, the third optical compensation element 230 may be adhered to the first optical compensation element 210 or the TFT array substrate 10, or may be integrated with a support body that is provided separately from the TFT array substrate 10.

As shown in FIG. 21, the third optical compensation element 230 is formed of a negative uniaxial retardation film (that is, C plate). The optical axis 231 of the third optical compensation element 230 is oriented along the direction (that is, Z direction) of the normal line of a plane (that is, XY-plane or the substrate plane of the TFT array substrate 10) of the third optical compensation element 230, which faces the first optical compensation element 210. Thus, the index ellipsoid 232 is also oriented along the direction of the normal line (that is, Z direction).

Owing to the above configured third optical compensation element 230, it is possible to further reliably compensate for a light phase difference that occurs when light passes through the liquid crystal layer 50. In other words, by means of the first optical compensation element 210, the second optical compensation element 220 and the third optical compensation element 230, it is possible to further reduce the anisotropy of overall refractive index of a set of the liquid crystal layer 50, the first optical compensation element 210, the second optical compensation element 220 and the third optical compensation element 230.

Particularly in the present embodiment, the third optical compensation element 230 is, for example, formed of an inorganic material using a vapor deposition method, or the like. Thus, the third optical compensation element 230 substantially or completely does not exhibit degradation due to ultraviolet light, or the like.

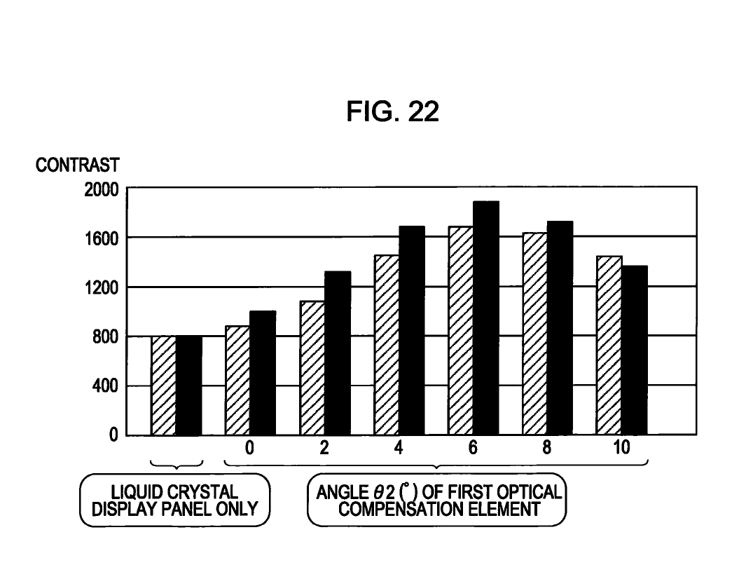

Next, with reference to FIG. 22, the quantitative relationship between an angle θ2 of the first optical compensation element and a variation in contrast in accordance with the angle θ2 when the second optical compensation element according to the seventh embodiment is used and when an optical film according to a comparative example is used in place of the second optical compensation element. Here, FIG. 22 is a graph that shows the quantitative relationship between the angle θ2 of the first optical compensation element and a variation in contrast in accordance with the angle θ2 when the second optical compensation element according to the seventh embodiment is used and when an optical film according to the comparative example is used. Note that the ordinate axis of FIG. 22 represents the magnitude of contrast, and the abscissa axis of FIG. 22 represents the angle θ2 of the first optical compensation element. In addition, a black bar graph between two kinds of bar graph in FIG. 22 corresponds to the case in which the second optical compensation element according to the present embodiment is used, and a diagonally-shaped bar graph between two kinds of bar graph in FIG. 22 corresponds to the case in which an optical film is used in place of the second optical compensation element according to the comparative example.

Particularly, in FIG. 22, the front phase difference of the second optical compensation element according to the present embodiment is 20 nm (nanometer), and the front phase difference of the optical film according to the comparative example is substantially equal to the front phase difference of the second optical compensation element, that is, approximately 20 nm, In addition, in FIG. 22, the present embodiment and the comparative example both satisfies the following three common conditions. That is, these three common conditions are the thickness of the first optical compensation element 210 is 35 μm, the retardation (Δn·d) of the third optical compensation element 230 in the Z direction is 300 nm, and the pretilt angle α of the liquid crystal display panel 100 is 5 degrees.

According to the research conducted by the inventors of the present application, as an example thereof is shown by the black bar graphs and the diagonally-shaded bar graphs in FIG. 22, it has turned out that, even when the angle θ2 of the first optical compensation element is any angle within the range from 0 degrees to 8 degrees, the contrast is larger when the second optical compensation element according to the present embodiment is used than when the optical film according to the comparative example is used. In addition to this fact, because the second optical compensation element according to the present embodiment typically includes the inorganic film 223 that includes an inorganic material, it is possible to effectively prevent degradation of the second optical compensation element due to irradiation of light and a following increase in temperature and, hence, a reliable liquid crystal device may be formed.

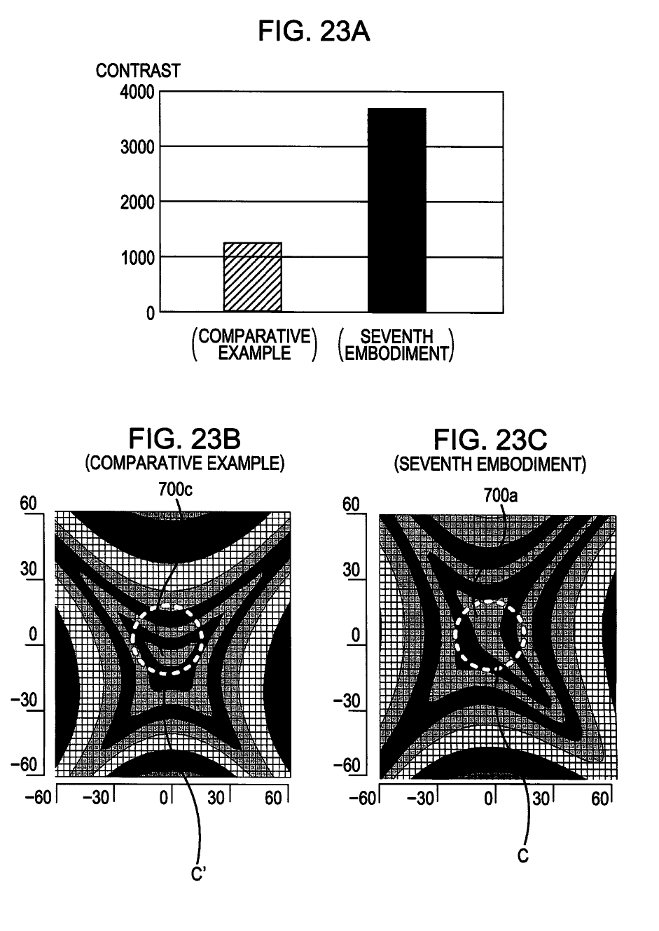

Next, with reference to FIG. 23A to FIG. 23C, by focusing attention on the degree of contrast improvement and the viewing angle range, the effect is studied when the first optical compensation element 210, the second optical compensation element 220 and the third optical compensation element 230 are used according to the seventh embodiment and when these first optical compensation element 210, second optical compensation element 220 and third optical compensation element 230 are not used according to a comparative example. Here, FIG. 23A is a graph that shows the quantitative relationship between the contrast of the seventh embodiment and the contrast of the comparative example. FIG. 23B is a viewing angle range characteristic chart of the liquid crystal device according to the comparative example. FIG. 23C is a viewing angle range characteristic chart of the liquid crystal device according to the seventh embodiment. Note that the ordinate axis of FIG. 23A represents the magnitude of contrast. In addition, between two kinds of bar graph in FIG. 23A, a black bar graph corresponds to the seventh embodiment, and a diagonally-shaded bar graph corresponds to the comparative example.

In the above simulation, the liquid crystal display panel 100 includes a liquid crystal layer, of which the pretilt angle α is 5 degrees, the birefringence (that is, Δn) is 0.14, and the thickness, that is, GAP, of the liquid crystal layer 50 is 2.7 μm, as the liquid crystal layer 50. Furthermore, in this simulation, the angle θ1 at which the optical axis 211 of the first optical compensation element 210 is inclined is 5 degrees (that is, equal to the pretilt angle α), and the thickness of the first optical compensation element 210 is 35 μm. The retardation of the third optical compensation element 230 in the Z direction is 300 nm. Moreover, in the above simulation, the front phase difference of the second optical compensation element 220 is 20 nm.

According to the above simulation, as an example thereof is shown by the black bar graph and the diagonally-shaded bar graph in FIG. 23A, it has turned out that the contrast of the liquid crystal device according to the seventh embodiment is larger than that of the liquid crystal device according to the comparative example. In detail, it has turned out that the contrast of the liquid crystal device according to the seventh embodiment is approximately three times (=3728/1291) as large as the contrast of the liquid crystal device according to the comparative example. Thus, by providing the liquid crystal display panel 100 with the three elements, that is, the first optical compensation element 210, the second optical compensation element 220 and the third optical compensation element 230, it is possible to effectively enhance the contrast.

In FIG. 23B and FIG. 23C, the contrast is calculated for each polar angle (that is, an angle at which the normal line of the display screen of the liquid crystal display panel makes with the direction of measurement or observation) in each azimuth, and the contrast is mapped for each polar angle in each azimuth. In addition, regions of the same kind exhibit a contrast within the same range. FIG. 23B and FIG. 23C show that, as it approaches a circle C or a circle C′, each having the same radius in the drawings, the contrast increases. In addition, positions that are located along a direction from the center of the viewing angle range characteristic chart to an outer periphery represent the values of polar angle in the same azimuth. As shown in FIG. 23B and FIG. 23C, the contrast depends on an azimuth and a polar angle.

A region 700a that exhibits a high contrast in the liquid crystal device according to the seventh embodiment shown in FIG. 23C (that is, the liquid crystal device formed of the liquid crystal display panel 100 that includes the first optical compensation element 210, the second optical compensation element 220 and the third optical compensation element 230) is wider than a region 700c (that is, a region that exhibits a contrast of the same range as the contrast exhibited by the region 700a in the liquid crystal device according to the seventh embodiment shown in FIG. 23C) that exhibits a high contrast in the liquid crystal device according to the comparative example shown in FIG. 23B (that is, the liquid crystal device formed of the liquid crystal display panel 100 singly). Moreover, in comparison with the region 700c, the region 700a is wide, that is, the viewing angle range is wide, even when focusing on a range (in the drawing, a region inside the circle C and a region inside the circle C′, which are indicated by the broken lines) in which the polar angle is 0 degrees to 15 degrees, at which a relatively high contrast is required when the liquid crystal device is used as a liquid crystal light bulb of a projector. Thus, as shown in FIG. 23C, the liquid crystal device according to the seventh embodiment is able to enhance the contrast when projection display is performed as compared with, for example, the liquid crystal device according to the comparative example shown in FIG. 23B.

### Eighth Embodiment

A liquid crystal device according to an eighth embodiment will be described with reference to FIG. 24. FIG. 24 is a cross-sectional view of the liquid crystal device, similar to FIG. 16, according to the eighth embodiment. Note that, in FIG. 24, the same reference numerals are assigned to the same components as those of the sixth embodiment shown in FIG. 16 to FIG. 19 and those of the seventh embodiment shown in FIG. 20 and FIG. 21, and the description thereof is omitted where appropriate.

In FIG. 24, the liquid crystal device according to the eighth embodiment differs from the liquid crystal device according to the seventh embodiment in that the second optical compensation element 220c is provided in place of the second optical compensation element 220 of the above described seventh embodiment, and the portions other than the above have substantially the same configuration as those of the liquid crystal device according to the above described seventh embodiment.

As shown in FIG. 24, the liquid crystal device according to the eighth embodiment includes the liquid crystal display panel 100, the microlens array 400, the first optical compensation element 210, the second optical compensation element 220c, the third optical compensation element 230 and the polarizers 310 and 320.

Particularly, the present embodiment differs from the second optical compensation element 220 of the above described seventh embodiment in that the second optical compensation element 220c is provided between the incident side polarizer 310 and the liquid crystal display panel 100 (more specifically, between the polarizer 310 and the microlens array 400), and the portion other than the above have substantially the same configuration as that of the second optical compensation element according to the above described seventh embodiment.

Thus, when the liquid crystal device is, for example, provided in a projector as a light bulb, the second optical compensation element 220c may be easily adjusted by rotation so that it does not substantially or completely contact other members.

### Ninth Embodiment

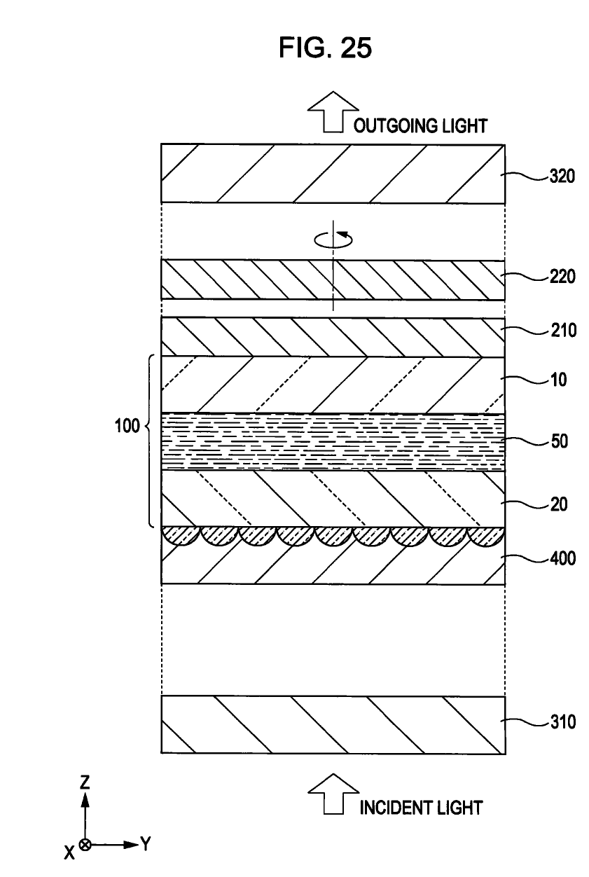

A liquid crystal device according to a ninth embodiment will be described with reference to FIG. 25 to FIG. 28.

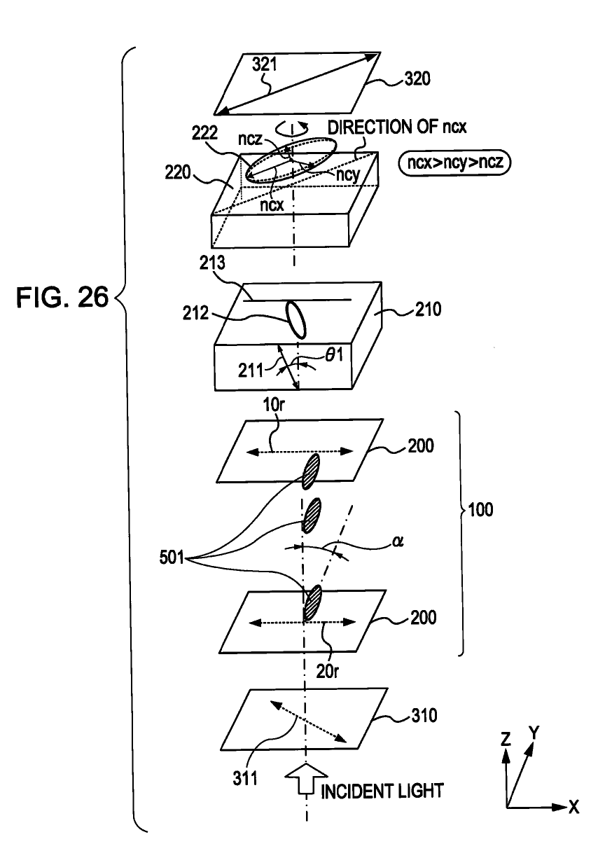

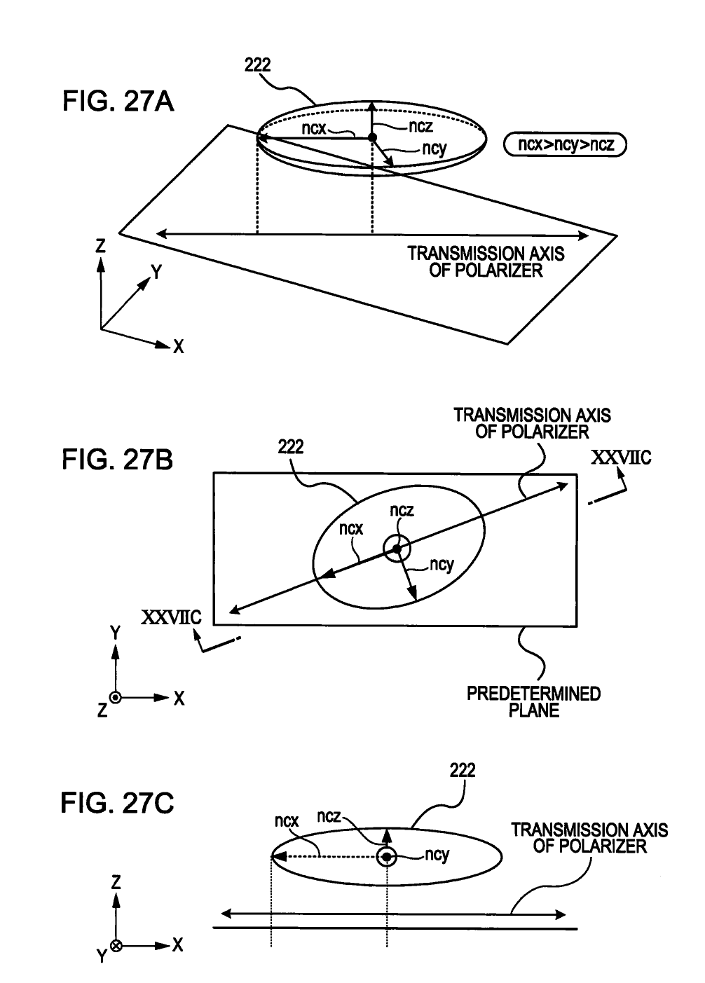

First, positions at which the first and second optical compensation elements and the polarizers are arranged in the liquid crystal device according to the ninth embodiment will be described with reference to FIG. 25. Here, FIG. 25 is a cross-sectional view of the liquid crystal device according to the present embodiment, showing the configuration of the liquid crystal device and the incident direction in which incident light enters the liquid crystal device according to the present embodiment. Note that, in the following drawings, among the components shown in FIG. 1 and FIG. 2, the detailed components of the liquid crystal display panel 100 will be omitted appropriately and only the components that are directly relevant will be shown. In addition, for the sake of convenience, FIG. 25 is a view that is obtained by turning the TFT array substrate 10 and the opposite substrate 20, shown in FIG. 2, upside down. In addition, the X direction, the Y direction and the Z direction in FIG. 26, FIG. 27, and the like, which will be described later, in addition to FIG. 25, are common throughout the present embodiment. The Z direction represents a direction in which light advances. The X direction is perpendicular to the Z direction. The Y direction is perpendicular to the Z direction and the X direction. A planar direction defined by the X direction and the Y direction represents the planar direction of a polarizing glass or the liquid crystal display panel. In addition, when the X direction, the Y direction and the Z direction are indicated, a direction denoted by a circle in which X is arranged indicates a direction toward the far side of the sheet, a direction denoted by a circle in which a black circle is arranged indicates a direction toward the near side of the sheet.

As shown in FIG. 25, the liquid crystal device according to the present embodiment includes the liquid crystal display panel 100, the microlens array 400, the first optical compensation element 210, the second optical compensation element 220 and the polarizers 310 and 320. The liquid crystal display panel 100, the microlens array 400, the first optical compensation element 210 and the second optical compensation element 220 are arranged so as to be held between the polarizers 310 and 320.

The microlens array 400 is a microlens array plate in which microlenses corresponding to pixels of the liquid crystal display panel 100 are formed. The microlens array 400 is provided between the incident side polarizer 310 and the liquid crystal display panel 100. Owing to the microlens array 400, incident light may be collected in units of pixels, and an actual aperture ratio of the liquid crystal display panel 100 may be improved.

The first optical compensation element 210 and the second optical compensation element 220 are provided between the outgoing side polarizer 320 and the liquid crystal display panel 100. The first optical compensation element 210 is adhered to the TFT array substrate 10. The second optical compensation element 220 is supported by a support body, which is provided separately from the TFT array substrate 10, between the first optical compensation element 210 and the outgoing side polarizer 320. The second optical compensation element 220 is configured to be rotatable about an axis along the normal line of the substrate plane of the TFT array substrate 10.

Next, the configuration of the first and second optical compensation elements and the polarizers according to the present embodiment will be described with reference to FIG. 26. Here, FIG. 26 is a perspective view of the first optical compensation element, the second optical compensation element and the polarizers according to the present embodiment. Note that, in FIG. 26, in addition to the first and second optical compensation elements and the polarizers, the status of liquid crystal molecules in the liquid crystal display panel 100, when no voltage is applied, is conceptionally shown. In addition, in FIG. 26, for the sake of convenience, an angle α and an angle θ1 are shown so as to be larger than the actual angles.

In FIG. 26, the liquid crystal molecules 501 in the liquid crystal layer 50, when no voltage is applied, are pretilted by the alignment layers 22 and 16 (see FIG. 2) within the plane of the opposite substrate 20 (or the TFT array substrate 10) at a predetermined angle from the plane in a predetermined direction (in a direction along the tilt direction 20r of the liquid crystal located adjacent to the boundary of the alignment layer 22 (that is, the tilt direction 10r of the liquid crystal located adjacent to the boundary of the alignment layer 16), which extends in a direction along an X direction in FIG. 26), and are aligned obliquely at a pretilt angle α with respect to the normal line of the opposite substrate 20 (or the TFT array substrate 10).

Each of the polarizers 310 and 320 is, for example, a polarizer that includes a polarizing film, formed of a PVA, or the like, that regulates polarization of light and a protective layer, formed of a TAC, or the like, that is arranged on each side of the polarizing film. The polarizer 310 is provided on a side of the liquid crystal display panel 100, from which light enters so as to face the opposite substrate 20. The polarizer 320 is provided on a side of the liquid crystal display panel 100, from which light exits so as to face to the TFT array substrate 10. The polarizers 310 and 320 are arranged in crossed-Nichols such that the polarization axis 311 of the polarizer 310 intersects perpendicularly with the polarization axis 321 of the polarizer 320. Each of the polarization axes 311 and 321 is oriented along a direction that is deviated at an angle of approximately 45 degrees from the tilt direction 20r of the liquid crystal located adjacent to the boundary of the alignment layer 22 (that is, the tilt direction 10r of the liquid crystal located adjacent to the boundary of the alignment layer 16). Because alignment of the liquid crystal molecules 501 of the liquid crystal layer 50 is controlled in the VA mode as described above, the liquid crystal device according to the present embodiment displays an image in a normally black mode in which black is displayed on the image display area 10a (see FIG. 1) when no voltage is applied to the liquid crystal layer 50.

The first optical compensation element 210 is, for example, formed of a crystal plate that is formed from a positive uniaxial crystal, such as rock crystal. The optical axis 211 of the first optical compensation element 210 is inclined in a direction that is different from a direction, in which the major axes of the liquid crystal molecules 501 incline, with respect to the plane of the first optical compensation element 210, which faces the liquid crystal display panel 100 (that is, XY-plane). That is, for example, when viewed within one plane that is perpendicular to the TFT array substrate 10 along the tilt direction 10r, the optical axis 211 is inclined with respect to the normal line of the TFT array substrate 10 (that is, Z-axis) at an angle θ1 in a direction that is different from a direction in which the major axes of the liquid crystal molecules 501 incline. Thus, the estimated index ellipsoid 212 is also inclined at an angle θ1 with respect to the normal line of the TFT array substrate 10 in a direction that is different from a direction in which the major axes of the liquid crystal molecules 501 incline. The phase retardation axis 213 of the first optical compensation element 210 is oriented along the tilt direction 10r of the liquid crystal located adjacent to the boundary of the alignment layer 16 (that is, the tilt direction 20r of the liquid crystal located adjacent to the boundary of the alignment layer 22 or the X direction). More specifically, the first optical axis 211 is oriented along a direction that is symmetrical with the major axes of the pretilted liquid crystal molecules 501 with respect to the plane of the first optical compensation element 210, which faces the liquid crystal display panel 100 (that is, XY-plane), and the angle θ1 is set so as to be substantially or practically completely equal to the pretilt angle α.

Note that the first optical compensation element 210, as described with reference to FIG. 5, may be formed in such a manner that a positive uniaxial crystal is cut along the two cutting plane lines that are inclined at a predetermined angle with respect to the optical axis and is then polished so as to have a predetermined thickness.

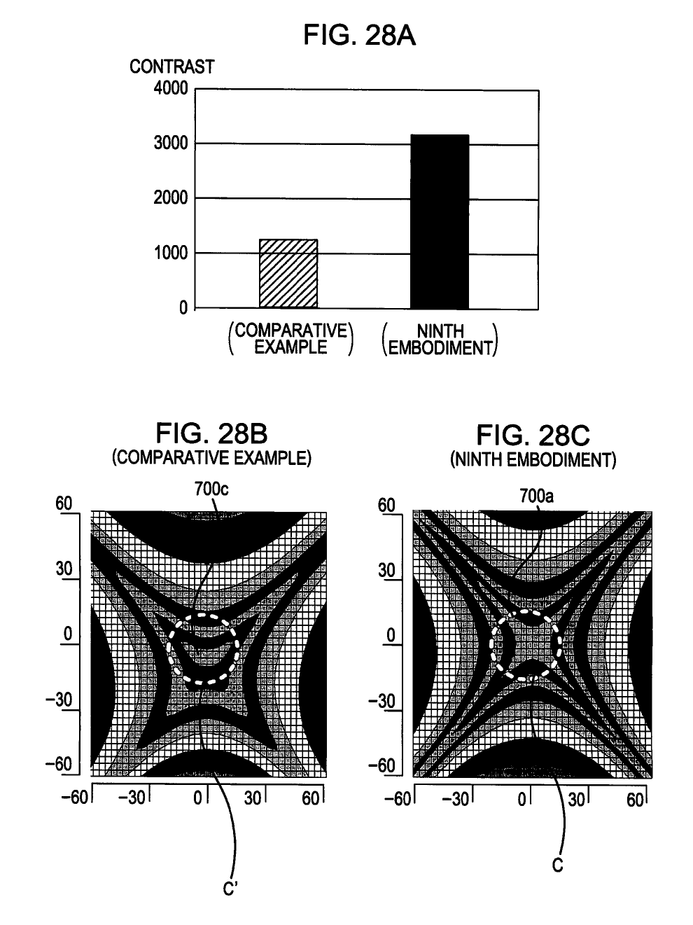

Next, the configuration of the second optical compensation element according to the present embodiment will be described with reference to the above described FIG. 26 together with FIG. 27A to FIG. 27C and FIG. 28A to FIG. 28C. Here, FIG. 27A is an outside perspective view that schematically shows the positional relationship between a biaxial index ellipsoid and the substrate plane (that is, XY-plane) of the TFT array substrate according to the present embodiment. FIG. 27B is a plan view that schematically shows the positional relationship between the biaxial index ellipsoid and the substrate plane of the TFT array substrate. FIG. 27C is a cross-sectional view that is taken along the line XXVIIC-XXVIIC in FIG. 27B. FIG. 28 is a cross-sectional view that shows the configuration of the second optical compensation element according to the present embodiment.

In the above described FIG. 26 and FIG. 27A to FIG. 27C, the second optical compensation element 220 has the biaxial optical anisotropy 222, and the refractive index of the biaxial optical anisotropy 222 satisfies the following conditional expression (1).

(refractive index ncx)>(refractive index ncy)>(refractive index ncz) (1)

In this manner, a phase retardation axis occurs in the second optical compensation element 220 because of the axis ncx of the main refractive index of the biaxial index ellipsoid 222. Here, the phase retardation axis according to the present embodiment means a direction in which the refractive index is maximal in one plane (in other words, a direction in which speed of light is minimal). Furthermore, the phase retardation axis that occurs in the second optical compensation element 220 is configured to be rotatable about an axis along the direction of the normal line of the TFT array substrate 10 (that is, Z direction). Typically, the direction in which the phase retardation axis extends may be made parallel to the polarization axis of the polarizer. Furthermore, the second optical compensation element 220 is arranged so as to face the first optical compensation element 210.

Typically, as shown in FIG. 27A, the case in which the refractive index ncx that is the maximum refractive index in the above described biaxial index ellipsoid 222 is arranged along the substrate plane of the TFT array substrate 10 (that is, XY-plane) will be described. In this case, as shown in the plan view of FIG. 27B, the direction of the refractive index ncx that is the maximum refractive index in the biaxial index ellipsoid 222 may be aligned parallel to the polarization axis of the polarizer. In addition, FIG. 27C is a cross-sectional view of the biaxial index ellipsoid 222 by taking the plane, that is oriented along the refractive index ncx, as the line XXVIIC-XXVIIC in FIG. 27B. In FIG. 27C as well, the biaxial index ellipsoid 222, which is the maximum refractive index, is shown.

Typically, the above described second optical compensation element 220 may be formed of a birefringent compound or polymer and may be a drawn optical film or a drawn polymer film. By means of the above optical film, or the like, it is possible to easily create the second optical compensation element 220 to which the phase retardation axis is set appropriately. The birefringent material that forms the second optical compensation element 220 may be a polymer that has a side chain that has such a structure that combines a substituent group, such as biphenyl, terphenyl, phenyl benzoate, or azobenzene, which is heavily used as a mesogen component of a liquid crystalline polymer, with a photosensitive group, such as cinnamic acid group (or its derivative group) and a principal chain that has a structure, such as hydrocarbon, acrylate, methacrylate, maleimide, N-phenyl maleimide, or siloxane. The polymer may be a homopolymer that is formed of the same repeated units or a copolymer that is formed of units that include side chains having different structures, or may be obtained by copolymerizing a unit that includes a side chain having no photosensitive group.

Moreover, as will be described later, particularly in the present embodiment, the second optical compensation element 220 is adjusted by rotation so as to cancel a light phase difference that occurs because of the liquid crystal layer 50 and the first optical compensation element 210. In addition, the second optical compensation element 220 also has the function of minutely adjust the state of polarization of light.

Next, the operation of the above configured liquid crystal device according to the present embodiment will be described with reference to FIG. 6 together with FIG. 25 and FIG. 26.

As shown in FIG. 25, when the liquid crystal device according to the present embodiment is operating, incident light initially enters the incident side polarizer 310. Note that the polarizer 310 only transmits light that oscillates in a direction along the polarization axis 311. That is, incident light becomes linearly polarized light after passing through the polarizer 310. The incident light that has passed through the polarizer 310 passes through the microlens array 400 and the opposite substrate 20 and then enters the liquid crystal layer 50.

As shown in FIG. 26, the liquid crystal molecules 501 in the liquid crystal layer 50, when no voltage is applied, are aligned obliquely at the pretilt angle α in a direction along the tilt direction 10r (that is, a positive X-axis direction) with respect to the direction of the normal line of the TFT array substrate 10 (that is, Z direction). Thus, as shown in FIG. 26, the index ellipsoid 501e that indicates the anisotropy of refractive index of the overall liquid crystal layer 50 is also inclined at the pretilt angle α in a direction along the tilt direction 10r (that is, the positive X-axis direction) with respect to the direction of the normal line of the TFT array substrate 10 (that is, Z direction). Therefore, if no measure is taken, light that has entered the liquid crystal layer 50 has a phase difference because the index ellipsoid 501e of the liquid crystal layer 50 is inclined at the pretilt angle α, so that the light that has passed through the liquid crystal layer 50 enters the outgoing side polarizer 320 in a state where the phase of the light is shifted. In addition, there is a possibility that a phase difference may occur when incident light passes through the microlens array 400 or the polarizer 310 or 320. Thus, in the outgoing side polarizer 300b, there is a possibility that light, which is normally not allowed be passed, will leak.

Then, as shown in the above described FIG. 26 and FIG. 6, because the liquid crystal device according to the present embodiment includes the first optical compensation element 210 and the second optical compensation element 220, it is possible to compensate for a light phase difference that occurs when incident light passes through the liquid crystal layer 50. In other words, by means of the first optical compensation element 210 and the second optical compensation element 220, it is possible to reduce the anisotropy of overall refractive index of a set of the liquid crystal layer 50, the first optical compensation element 210 and the second optical compensation element 220. In short, the first optical compensation element 210, which has the index ellipsoid 212 inclined at the angle θ1 to a side opposite to that of the estimated index ellipsoid 501e, is arranged for the liquid crystal layer 50 that has the estimated index ellipsoid 501e inclined at the pretilt angle α, so that the estimated overall index ellipsoid 292 of a set of the liquid crystal layer 50 and the first optical compensation element 210 is approximated to a biaxial index ellipsoid. Thus, it is possible for the first optical compensation element 210 to compensate for a phase difference that occurs from a state in which the index ellipsoid 501e of the liquid crystal layer 50 is inclined at the pretilt angle α. Furthermore, the above described second optical compensation element 220, that is, the second optical compensation element 220 that has the biaxial index ellipsoid 222 of which the phase retardation axis is oriented along the substrate plane of the TFT array substrate 10 (that is, XY-plane) is adjusted by rotation so as to cancel a light phase difference that occurs because of the liquid crystal layer 50 and the first optical compensation element 210. Thus, it is possible to reduce the anisotropy of overall refractive index of a set of the liquid crystal layer 50, the first optical compensation element 210 and the second optical compensation element 220. In other words, the second optical compensation element 220 is, for example, adjusted by rotation so that, when no voltage is applied, light substantially or completely does not exit from the outgoing side polarizer 320, so that it is possible to reliably compensate for a light phase difference that occurs because of the liquid crystal layer 50 and the first optical compensation element 210.

By performing the above compensation, it is possible to prevent light, which has passed through the liquid crystal layer 50, from entering the outgoing side polarizer 320 in a state where the phase is shifted. Furthermore, because the second optical compensation element 220 has the function of adjusting the state of polarization of light, it is possible to allow light to enter the outgoing side polarizer 320 in a further appropriate state of polarization. Thus, for example, in the outgoing side polarizer 320, there is less possibility that light, which is normally not allowed to be passed, will leak, and thereby it is possible to prevent a decrease in contrast and a reduction in viewing angle range.

Furthermore, although the first optical compensation element 210 and the second optical compensation element 220 are never arranged obliquely with respect to the TFT array substrate 10 or the opposite substrate 20, it is possible to compensate for a light phase difference that occurs in the liquid crystal layer 50. Thus, it is suitable for miniaturization of the liquid crystal device, and the like.

Note that it is desirable that the retardation (Δn·d) of the first optical compensation element 210 with respect to the Z direction is substantially or completely equal to the retardation of the liquid crystal layer 50 with respect to the Z direction. In this case, it is possible to further enhance the advantageous effect in compensating for a phase difference that occurs in the liquid crystal layer 50. However, if the retardation of the first optical compensation element 210 in the Z direction is not substantially or completely equal to the retardation of the liquid crystal layer 50 in the Z direction, it is possible to appropriately enhance the advantageous effect in compensating for a phase difference that occurs in the liquid crystal layer 50 in accordance with a difference between the retardation of the first optical compensation element 210 in the Z direction and the retardation of the liquid crystal layer 50 in the Z direction. That is, for example, when the retardation of the liquid crystal layer 50 in the Z direction is 300 nm, the retardation of the first optical compensation element 210 is desirably 300 nm; however, when the retardation of the first optical compensation element 210 is, for example, within a range of 200 nm to 400 nm, it is possible to reliably enhance the advantageous effect in compensating for a phase difference that occurs in the liquid crystal layer 50. In addition, the retardation of the second optical compensation element 220 in the Z direction is desirably within a range of, for example, 100 nm to 200 nm, and the front phase difference is desirably from about 20 nm to 50 nm. In this case, by the second optical compensation element 220 that is adjusted by rotation, it is possible to reliably obtain the advantageous effect in compensating for a light phase difference that occurs because of the liquid crystal layer 50 and the first optical compensation element 210.

In addition, particularly in the present embodiment, the first optical compensation element 210 and the second optical compensation element 220 are provided on the side of the liquid crystal display panel 100, from which light exits. That is, the first optical compensation element 210 and the second optical compensation element 220 are arranged on the side of the microlens array 400, from which light exits. Thus, it is possible for the first optical compensation element 210 and the second optical compensation element 220 to reliably compensate for a phase difference that occurs when light that is refracted by the microlens array 400 passes through the liquid crystal layer 50. In other words, it is possible to substantially or completely eliminate an adverse effect based on a light phase difference caused by the microlens array 400. Note that the first optical compensation element 210 and the second optical compensation element 220 may be provided on the side of the liquid crystal display panel 100, from which light enters (in other words, the side of the liquid crystal layer 50, from which light enters). In this case as well, it is possible to obtain the advantageous effect in compensating for a light phase difference.

As described above, the liquid crystal device according to the present embodiment is able to compensate for a phase difference that occurs in the liquid crystal layer 50 by means of the first optical compensation element 210 and the second optical compensation element 220. Thus, the liquid crystal device is able to display a relatively high-contrast and high-quality image and is also suitable for miniaturization.

Next, with reference to FIG. 28A to FIG. 28C, by focusing attention on the degree of contrast improvement and the viewing angle range, the effect is studied when the first optical compensation element 210 and the second optical compensation element 220 are used according to the present embodiment and when these first optical compensation element 210 and second optical compensation element 220 are not used according to a comparative example. Here, FIG. 28A is a graph that shows the quantitative relationship between the contrast of the present embodiment and the contrast of the comparative example. FIG. 28B is a viewing angle range characteristic chart of the liquid crystal device according to the comparative example. FIG. 28C is a viewing angle range characteristic chart of the liquid crystal device according to the present embodiment. Note that the ordinate axis of FIG. 28A represents the magnitude of contrast. In addition, between two kinds of bar graph in FIG. 28A, a black bar graph corresponds to the present embodiment, and a diagonally-shaded bar graph corresponds to the comparative example.

In the above simulation, the liquid crystal display panel 100 includes a liquid crystal layer, of which the pretilt angle α is 5 degrees, the birefringence (that is, Δn) is 0.14, and the thickness, that is, GAP, of the liquid crystal layer 50 is 2.7 μM, as the liquid crystal layer 50. Furthermore, in this simulation, the angle θ1 at which the optical axis 211 of the first optical compensation element 210 is inclined is 5 degrees (that is, equal to the pretilt angle α), and the thickness of the first optical compensation element 210 is 35 μm. Moreover, in the above simulation, the front phase difference of the second optical compensation element 220 is 50 nm, and the phase difference in the thickness direction of the second optical compensation element 220, that is, the Z direction is 200 nm.

According to the above simulation, as an example thereof is shown by the black bar graph and the diagonally-shaded bar graph in FIG. 28A, it has turned out that the contrast of the liquid crystal device according to the present embodiment is larger than that of the liquid crystal device according to the comparative example. In detail, it has turned out that the contrast of the liquid crystal device according to the present embodiment is approximately three times (=3068/1291) as large as the contrast of the liquid crystal device according to the comparative example. Thus, by providing the liquid crystal display panel 100 with the first optical compensation element 210 and the second optical compensation element 220, it is possible to effectively enhance the contrast.

In FIG. 28B and FIG. 28C, the contrast is calculated for each polar angle (that is, an angle at which the normal line of the display screen of the liquid crystal display panel makes with the direction of measurement or observation) in each azimuth, and the contrast is mapped for each polar angle in each azimuth. In addition, regions of the same kind exhibit a contrast within the same range. FIG. 28B and FIG. 28C show that, as it approaches a circle C or a circle C′, each having the same radius in the drawings, the contrast increases. In addition, positions that are located along a direction from the center of the viewing angle range characteristic chart to an outer periphery represent the values of polar angle in the same azimuth. As shown in FIG. 28B and FIG. 28C, the contrast depends on an azimuth and a polar angle.

The region 700a that exhibits a high contrast in the liquid crystal device according to the ninth embodiment shown in FIG. 28C (that is, the liquid crystal device formed of the liquid crystal display panel 100 that includes the first optical compensation element 210 and the second optical compensation element 220 according to the ninth embodiment) is wider than the region 700c (that is, a region that exhibits a contrast of the same range as the contrast exhibited by the region 700a in the liquid crystal device according to the present embodiment shown in FIG. 28C) that exhibits a high contrast in the liquid crystal device according to the comparative example shown in FIG. 28B (that is, the liquid crystal device formed of the liquid crystal display panel 100 singly). Moreover, in comparison with the region 700c, the region 700a is wide, that is, the viewing angle range is wide, even when focusing on a range (in the drawing, a region inside the circle C and a region inside the circle C′, which are indicated by the broken lines) in which the polar angle is 0 degrees to 15 degrees, at which a relatively high contrast is required when the liquid crystal device is used as a liquid crystal light bulb of a projector. Thus, as shown in FIG. 28C, the liquid crystal device according to the present embodiment is able to enhance the contrast when projection display is performed as compared with, for example, the liquid crystal device according to the comparative example shown in FIG. 28B.

### Electronic Apparatus

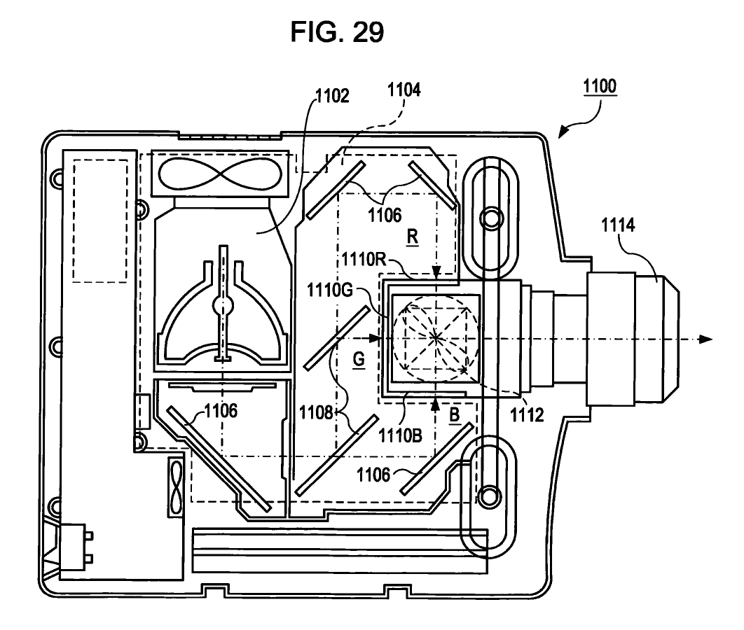

Next, an example of an electronic apparatus that uses the above described liquid crystal device will be described with reference to FIG. 29. The electronic apparatus according to the present embodiment is a projector that uses the above described liquid crystal device as a light bulb.

FIG. 29 is a plan view that shows an example of the configuration of a projector. As shown in FIG. 29, a projector 1100 installs therein a lamp unit 1102 formed of a white light source, such as a halogen lamp. Light projected from the lamp unit 1102 is split into three primary colors, that is, RGB, by four mirrors 1106 and two dichroic mirrors 1108, which are arranged in a light guide 1104 and then enter liquid crystal display panels 1110R, 1110B and 1110G, which are light valves corresponding to the primary colors.

The configurations of the liquid crystal display panels 1110R, 1110B and 1110G have the equivalent configuration to the above described liquid crystal device, and are respectively driven by primary color signals of R, G, B, which are supplied from an image signal processing circuit. Then, light modulated by these liquid crystal display panels enters a dichroic prism 1112 from the three directions. In this dichroic prism 1112, R light and B light are refracted at a right angle while, on the other hand, G light goes straight. Thus, by composing images corresponding to the respective colors, a color image is projected onto a screen, or the like, through a projection lens 1114.

Here, focusing on display images by the liquid crystal display panels 1110R, 1110B and 1110G, the display images of the liquid crystal display panels 1110R, 1110B need to be mirror reversed relative to the display image by the liquid crystal panel 1110G.

Note that, because rays of light corresponding to the primary colors of R, G, B enter the liquid crystal display panels 1110R, 1110B and 1110G by the dichroic mirrors 1108, no color filter needs to be provided.

Because the above projector includes the above described liquid crystal device, it is possible to display a high-contrast image by compensating for a phase difference that occurs in light that passes through the liquid crystal layer and, furthermore, it is possible to achieve miniaturization.

Note that, in addition to the electronic apparatus described with reference to FIG. 29, the electronic apparatus may include a mobile personal computer, a cellular phone, a liquid crystal television, a viewfinder type or a direct view type video tape recorder, a car navigation system, a pager, a personal organizer, an electronic calculator, a word processor, a workstation, a video telephone, a POS terminal, and devices provided with a touch panel. Then, of course, the aspects of the disclosure may be applied to the above various electronic apparatuses.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present disclosure. Those with skill in the art will readily appreciate that embodiments in accordance with the present disclosure may be implemented in a very wide variety of ways. This application is intended to cover any adaptations or variations of the embodiments discussed herein. Therefore, it is manifestly intended that embodiments in accordance with the present disclosure be limited only by the claims and the equivalents thereof.

What is claimed is:

1. A liquid crystal device comprising:
a pair of substrates;
a liquid crystal between the pair of substrates;
an alignment layer between one of the substrates and the liquid crystal, the alignment layer providing a pretilt to the liquid crystal;
a first optical compensation element having a positive uniaxiality and a first optical axis inclined in a direction different from a direction in which major axes of the pretilted liquid crystal incline with respect to the pair of substrates; and
a second optical compensation element having a positive uniaxiality and a second optical axis aligned with the pair of substrates.

2. The liquid crystal device according to claim 1, wherein the first optical axis intersects with the second optical axis when viewed in a direction of a line normal to the pair of substrates.

3. The liquid crystal device according to claim 2, wherein the first optical axis is perpendicular to the second optical axis when viewed in the direction of the line normal to the pair of substrates.

4. The liquid crystal device according to claim 1, wherein the liquid crystal is a vertical alignment liquid crystal.

5. The liquid crystal device according to claim 4, wherein an angle, which the first optical axis makes with respect to the line normal to the pair of substrates, is equal to a pretilt angle, which the major axes of the pretilted liquid crystal make with respect to the line normal to the pair of substrates.

6. The liquid crystal device according to claim 1, wherein the first optical compensation element is formed of a crystal plate including a positive uniaxial crystal formed by polishing so an optical axis of the crystal plate is inclined with respect to a line normal to the pair of substrates.

7. The liquid crystal device according to claim 1, further comprising a third optical compensation element having a negative uniaxiality and a third optical axis oriented along the direction of a line normal to the pair of substrates.

8. The liquid crystal device according to claim 7, wherein the third optical compensation element is formed of an inorganic material.

9. The liquid crystal device according to claim 7, further comprising a microlens array arranged on a side of the pair of substrates from which light enters and wherein the third optical compensation element is provided on a side of the pair of substrates from which light exits.

10. The liquid crystal device according to claim 1, wherein the first and second optical compensation elements are provided on a side of the pair of substrates from which light exits.

11. An electronic apparatus comprising the liquid crystal device according to claim 1.

12. A liquid crystal device comprising:
a pair of substrates;
a liquid crystal between the pair of substrates;
an alignment layer between one of the substrates and the liquid crystal, the alignment layer aligning the liquid crystal with a pretilt;
a pair of polarizers sandwiching therebetween the pair of substrates;
a first optical compensation element, between the pair of polarizers, having a positive uniaxiality and a first optical axis inclined in a direction different from a direction in which major axes of the pretilted liquid crystal incline with respect to the pair of substrates; and
a second optical compensation element, between the pair of polarizers, having a phase retardation axis when viewed in a direction along a line normal to the pair of substrates, the second optical compensation element configured to rotate about a normal axis aligned with the line normal to the pair of substrates.

13. The liquid crystal device according to claim 12, wherein the second optical compensation element has a positive uniaxiality and a second optical axis aligned with the pair of substrates.

14. The liquid crystal device according to claim 12, wherein the second optical compensation element is adjusted by rotation to cancel a light phase difference occurring because of the liquid crystal and the first optical compensation element.

15. The liquid crystal device according to claim 12, wherein the second optical compensation element is rotated to adjust the state of polarization of light exiting from one of the pair of polarizers, arranged on a side of the pair of substrates which light enters, from a state in which the phase retardation axis is aligned with the polarization axis of any one of the pair of polarizers.

16. The liquid crystal device according to claim 12, wherein the second optical compensation element is provided on a side of the pair of substrates from which light enters.

17. A liquid crystal device comprising:
a pair of substrates;
a liquid crystal between the pair of substrates;
an alignment layer between one of the substrates and the liquid crystal;
liquid crystal molecules being pretilted by the alignment layer;
a pair of polarizers sandwiching therebetween the pair of substrates;
a first optical compensation element, between the pair of polarizers, having a positive uniaxiality and a first optical axis inclined in a direction different from a direction in which major axes of the pretilted liquid crystal molecules incline with respect to the pair of substrates; and
a second optical compensation element, between the pair of polarizers, having a negative index ellipsoid and a phase retardation axis, rotatable about a normal axis aligned with a line normal to the pair of substrates, occurring from a state in which a main axis of a refractive index of the negative index ellipsoid is inclined with respect to the pair of substrates.

18. The liquid crystal device according to claim 17, wherein the second optical compensation element includes (i) a predetermined substrate and (ii) an inorganic film formed on the predetermined substrate to supply an inorganic material in a direction oblique to a substrate plane of the predetermined substrate.

19. The liquid crystal device according to claim 17, wherein the second optical compensation element includes a negative biaxial index ellipsoid as the negative index ellipsoid.

20. A liquid crystal device comprising:
a pair of substrates;
a liquid crystal between the pair of substrates;
an alignment layer between one of the substrates and the liquid crystal;
liquid crystal molecules being pretilted by the alignment layer;
a pair of polarizers sandwiching therebetween the pair of substrates;
a first optical compensation element, between the pair of polarizers, having a positive uniaxiality and a first optical axis inclined in a direction different from a direction of major axes of the pretilted liquid crystal molecules configured to incline with respect to the pair of substrates; and
a second optical compensation element, between the pair of polarizers, having a biaxial index ellipsoid and a phase retardation axis rotatable about an axis aligned with a line normal to the pair of substrates.

21. The liquid crystal device according to claim 20, wherein the direction of a maximum main refractive index among three main refractive indices in the index ellipsoid is aligned with the pair of substrates.

22. The liquid crystal device according to claim 20, wherein the second optical compensation element is formed of a birefringent polymer and is a drawn optical film.

23. The liquid crystal device according to claim 20, wherein the second optical compensation element is adjusted by rotation to adjust a polarization state of light exiting from one of the polarizers, arranged on a side of the pair of substrates from which light enters, from a state in which the direction of a maximum main refractive index among three main refractive indices in the index ellipsoid is aligned with the polarization axis of one of the pair of polarizers.
